(19) United States
(12) Patent Application Publication
(10) Pub. No.: US 2025/0374390 A1
(43) Pub. Date: Dec. 4, 2025

(54) COOKING APPLIANCE WITH DIGITAL CONTROLLER DOOR AND METHOD FOR PROVIDING USER INTERFACE BASED ON OPERATION OF COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/222,721

(22) Filed: May 29, 2025

(30) Foreign Application Priority Data
May 30, 2024 (KR) 10-2024-0070766
Dec. 16, 2024 (KR) 10-2024-0187294

(51) Int. Cl. H05B 6/64; G06F 3/0481; G06F 3/0486; G06F 3/04886

(52) U.S. Cl. CPC H05B 6/6438; G06F 3/0481; G06F 3/0486; G06F 3/04886

(57) ABSTRACT

A cooking appliance can include a main portion including a cavity for receiving food, and being configured to provide a cooking function, a display door coupled to the main portion, and a controller. Also, the controller is configured to display a main control interface in the display, display a current screen in the display, the current screen including at least one of a cooking interface, an informational interface, a mini-controller interface and a temporal interface, and in response to at least one of receiving a touch input on the display, a condition change of the main portion or the display door, transition the current screen in the display to an updated screen that includes changing the at least one of cooking interface, an informational interface, a mini-controller interface and a temporal interface.

### CROSS-REFERENCE TO RELATED APPLICATION

This application claims priority to and the benefit of Korean Patent Application No. 10-2024-0070766, filed on May 30, 2024, and Korean Patent Application No. 10-2024-0187294, filed on Dec. 16, 2024, in the Republic of Korea, the entireties of all these applications are incorporated herein by reference.

### BACKGROUND

### Field

The present disclosure relates to a cooking appliance including a digital controller door and a method for providing a user interface based on an operation of the cooking appliance.

### Description of Related Art

A cooking appliance is a home appliance that cooks food using microwaves belonging to electromagnetic waves and/or heater heat. The cooking appliance can be generally provided with a cavity as a space in which food is placed and cooked, and a door for opening and closing the cavity.

When the cooking appliance is installed indoors, it is desirable to consider efficient use of the cooking appliance, saving of an installation space thereof, etc.

For this reason, the cooking appliance can be disposed at a position adjacent to a heating cooking device, for example, a heating oven, a gas stove, etc. Specifically, the cooking appliance can be disposed on top of the heating cooking device.

When the cooking appliance is disposed on top of the heating cooking device, the user can conveniently cook food by reducing the movement of the user in an environment in which the cooking appliance and the heating cooking device are adjacent to each other. In addition, heat, oil vapor, steam, etc. as generated from the heating cooking device can be discharged to the outside using the cooking appliance as a hood.

In a state in which the cooking appliance is disposed on top of the heating cooking device, heat, oil vapor, stream, or the like generated from the heating cooking device disposed under the cooking appliance can adversely affect the operation of the cooking appliance.

For example, a display can be mounted on a front surface of a door provided in the cooking appliance and can be configured to provide various information to the user. The user can know a cooking state of the cooked food through the display.

In addition, when the display is connected to another home appliance to serve as a hub of the home appliances, information other than cooking food can be obtained through the display. In addition, the user can input a command for cooking and various other commands to the display in a touch manner.

Therefore, a need exists for a display configured to provide an interface capable of controlling the cooking appliance while displaying various information and automatically switching between different views and interfaces based on changing conditions and in anticipation of the user's needs.

### SUMMARY OF THE DISCLOSURE

Thus, the present disclosure has been devised to solve the above problem. A purpose of the present disclosure is to provide an interface in which various software or hardware of a door coupled to the cooking appliance cooperates smoothly with a control component for controlling the cooking appliance, and the interface for controlling the cooking appliance can be provided.

Further, a purpose of the present disclosure is to provide a technology for providing a user interface for controlling the whole cooking appliance and a state of cooking, respectively, such that a user can conveniently control the cooking appliance.

Further, a purpose of the present disclosure is to provide a technology for providing a human interface (e.g., a user interface) based on a use pattern of the cooking appliance.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

A cooking appliance including a digital controller door (e.g., display door) according to an embodiment of the present disclosure includes a functional unit (e.g., main body or main portion of the cooking appliance) configured to provide a cooking function, and the digital controller door configured to instruct an operation of the functional unit and to provide a human interface, in which the digital controller door includes a display configured to display an image or video and configured to receive a touch input, and an operating system (OS) controller (e.g., door controller) configured to control each of components of the digital controller door, in which the OS controller is configured to display at least one of a main control interface, a cooking interface, an informational interface, mini-controller interface, and a temporal interface on the display, based on a function provided by the functional unit or a function provided by the digital controller door or a touch input onto the display.

A method for providing an interface on a cooking appliance according to an embodiment of the present disclosure is provided. The cooling appliance includes a functional unit (e.g., main portion) configured to provide a cooking function, and the digital controller door (e.g., display door) configured to instruct an operation of the functional unit and to provide a human interface. The method can include checking, via the OS controller (e.g., door controller), an interface corresponding to a function provided by the functional unit or a function provided by the digital controller door or a touch input on the display, and displaying, by the OS controller, at least one interface of a main control interface, a cooking interface, an informational interface, mini-controller interface, and a temporal interface on the display, based on the checking result.

A home appliance according to an embodiment of the present disclosure includes a functional unit (e.g., main oven portion), a display which instructs the operation of the functional unit and provides a human interface, and an OS controller (e.g., display controller) which controls the display, in which the display displays an image or video and receives a touch input, and the display is divided into a first area and a second area. In addition, the OS controller displays at least one of an interface for controlling the operation of the home appliance or an interface indicating the operation state of the home appliance on the first area of the display. The second area of the display displays an interface different from the interface output to the first area, and the interface displayed in the first area is displayed on the uppermost layer of the display and is in a state of being able to receive a touch input, and the OS controller removes or displays the interface displayed in the first area according to the touch input made to the display or the operation state of the home appliance.

The mini-controller is provided when exiting the cooking interface during cooking. During cooking, either the cooking interface or the mini-controller interface may be displayed.

In accordance with the present disclosure, the various software or hardware of the door coupled to the cooking appliance can cooperate smoothly with the control component for controlling the cooking appliance, and the interface for controlling the cooking appliance can be provided.

Further, in accordance with the present disclosure, the interface for providing interface-related control of the whole cooking appliance and the interface for controlling a cooking state thereof can be provided, respectively, such that a user can conveniently control the cooking appliance.

Further, in accordance with the present disclosure, the human interface (e.g., a user interface) can be provided based on a use pattern of the cooking appliance.

The effects of the present disclosure are not limited to the above-described effects, and those skilled in the art can easily derive various effects of the present disclosure from the configuration of the present disclosure.

### BRIEF DESCRIPTION OF DRAWINGS

The above and other objects, features, and advantages of the present disclosure will become more apparent to those of ordinary skill in the art by describing example embodiments thereof in detail with reference to the attached drawings, which are briefly described below.

FIG. 1 is a conceptual diagram of a cooking appliance including a digital controller door according to an embodiment of the present disclosure.

FIG. 2 is a diagram illustrating components of a digital controller door and components of a functional unit according to an embodiment of the present disclosure.

FIG. 3 is a diagram illustrating categories of functions performed by an OS controller and a function controller according to an embodiment of the present disclosure.

FIG. 4 is a perspective view illustrating a cooking appliance according to an embodiment of the present disclosure.

FIG. 5 is a diagram illustrating a state in which the digital controller door 100 is opened in FIG. 4 according to an embodiment of the present disclosure.

FIG. 6 is a perspective view illustrating a digital controller door of a cooking appliance according to an embodiment of the present disclosure.

FIG. 7 is a schematic view illustrating a position where a cooking appliance is disposed according to an embodiment of the present disclosure.

FIG. 8 is a diagram illustrating a configuration of classifying a human interface according to an embodiment of the present disclosure.

FIG. 9 is a diagram illustrating an example of a human interface according to an embodiment of the present disclosure.

FIG. 10 is a diagram in which a cooking interface according to an embodiment of the present disclosure is displayed.

FIG. 11 is a diagram in which a cooking interface according to another embodiment of the present disclosure is displayed.

FIG. 12 is a diagram showing an informational interface and a cooking interface according to an embodiment of the present disclosure.

FIG. 13 is a diagram illustrating a configuration of a mini-controller interface according to an embodiment of the present disclosure.

FIGS. 14 to 16 are diagrams illustrating a human interface according to an embodiment of the present disclosure.

FIG. 17, including parts a and b, is a diagram illustrating an implementation scheme of a pop-up interface, that is, a mini-controller interface, according to an embodiment of the present disclosure.

FIG. 18 is a diagram illustrating a process in which a mini-controller is displayed or disappears according to an embodiment of the present disclosure.

FIG. 19 is a diagram showing a flow of screen switching in a cooking completion process according to an embodiment of the present disclosure.

FIG. 20 is a diagram illustrating a process in which an OS controller provides a human interface according to an embodiment of the present disclosure.

FIG. 21 is a diagram illustrating a process of displaying a cooking interface according to an embodiment of the present disclosure.

FIG. 22 is a diagram illustrating a process of presenting a cooking time duration suitable for a cooking target material according to an embodiment of the present disclosure.

FIG. 23 is a diagram of storing and applying a location when a user has moved the location of a mini-controller interface according to an embodiment of the present disclosure.

### DETAILED DESCRIPTION OF THE EMBODIMENTS

Hereinafter, embodiments of the present disclosure will be described in detail with reference to the drawings so that those skilled in the art to which the present disclosure pertains can implement the present disclosure. The present disclosure can be implemented in several different forms and is not limited to the embodiments described herein.

In order to clearly describe the present disclosure, parts irrelevant to the description are omitted, and the same reference numerals refer to the same or similar components throughout the specification. Further, some embodiments of the present disclosure will be described in detail with reference to the example drawings. In adding reference numerals to the components of each drawing, the same components can be denoted by the same reference numerals as much as possible even though the components are shown in different drawings. In addition, in describing the present disclosure, when it is determined that a detailed description of related known components or functions can obscure the gist of the present disclosure, the detailed description thereof can be omitted.

It will be understood that, although the terms “first,” “second,” “third,” and so on can be used herein to describe various elements, components, areas, layers and/or units, these elements, components, areas, layers and/or units should not be limited by these terms. These terms are used to distinguish one element, component, area, layer or unit from another element, component, area, layer or unit. Thus, a first element, component, area, layer or unit as described under could be termed a second element, component, area, layer or unit, without departing from the spirit and scope of the present disclosure. It will be understood that when a first element or layer is referred to as being “connected to,” “jointed to” or “coupled to” a second element or layer, the first element can be directly connected to or jointed to or coupled to the second element or layer, or one or more intervening elements or layers can be present therebetween. In addition, it will also be understood that when an element or layer is referred to as being “between” two elements or layers, it can be the only element or layer between the two elements or layers, or one or more intervening elements or layers can also be present therebetween.

In addition, in the implementation of the present disclosure, the component can be subdivided for convenience of description. However, this component can be implemented in one device or module, or one component can be implemented to be distributed into a plurality of devices or modules.

The present disclosure relates to a technique for controlling a cooking appliance using a digital controller door disposed at a front surface of the cooking appliance.

According to the present disclosure, a door of a microwave oven disposed on an oven or a gas stove includes an LCD or OLED screen. An Android board of the LCD or OLED screen and a microcomputer of the microwave oven cooperate with each other. An LCD or OLED component operates according to various operating/external environments of the microwave oven or controls a specific function of the microwave oven.

The digital controller door (e.g., display door, or smart display door) of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD or OLED providing various user interfaces such as a touch screen, and is capable of storing and cooking food therein. And embodiments of the present disclosure is not limited to a specific display panel type. The features of various embodiments of the present disclosure can be partially or entirely coupled to or combined with each other and can be interlocked and operated in technically various ways, and the embodiments can be carried out independently of or in association with each other. Also, the term “can” used herein includes all meanings and definitions of the term “may.”

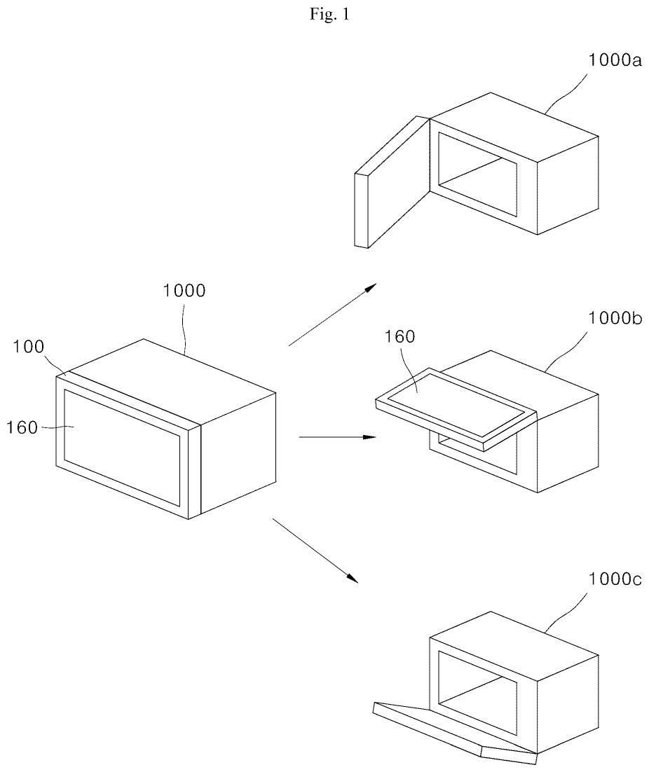

FIG. 1 is a conceptual diagram of a cooking appliance including a digital controller door according to an embodiment of the present disclosure.

The cooking appliance 1000 includes a digital controller door 100 at a front surface thereof. The digital controller door 100 includes one or two or more displays, and the display of the digital controller door 100 can display information about the inside of the cooking appliance 1000 or information related to an operation thereof to the user. The display of the digital controller door 100 can provide a touch input interface for receiving a predetermined command from the user.

A manner in which the digital controller door 100 is opened includes an embodiment 1000a, 1000b, or 1000c. 1000a shows an embodiment in which the digital controller door 100 pivots around a left side of the cooking appliance 1000a to open the right side of the cooking appliance 1000a, and open the inside of the cooking appliance 1000a. 1000b shows an embodiment in which the digital controller door 100 pivots around a top side of the cooking appliance 1000b to open the bottom side of the cooking appliance 100b, and open the inside of the cooking appliance 1000b. 1000c shows an embodiment in which the digital controller door 100 pivots around a bottom side of the cooking appliance 1000c to open the top side of the cooking appliance 1000c, and open the inside of the cooking appliance 1000c.

A display 160 can be mounted on the front surface of the digital controller door 100 to provide various information to a user. The user can know the cooking state of the cooked food on the display 160. The display 160 can be embodied as an LCD. However, embodiments of the present disclosure is not limited thereto, and the display 160 can include various display panels. In addition, a touch panel for touch input can be coupled to the display 160.

The digital controller door 100 (e.g., display door/touchscreen door) controls the operation of the cooking appliance 1000 and outputs various information. The cooking appliance 1000 performs cooking using microwaves or heater heat. Accordingly, a digital controlling function provided by the digital controller door 100 and a cooking function of the cooking appliance 1000 are provided in different ways and in different areas.

The digital controller door 100 of the present disclosure can serve as a kind of a hub (e.g., smart hub device). That is, the digital controller door 100 can serve as a hub of another home appliance and display information transmitted from another home appliance on the display 160. In this process, the user can obtain other information other than the cooking food on the display 160. In addition, the user can input a command for cooking and various other commands to the display 160 in a touch manner.

To this end, in accordance with the present disclosure, a method and a configuration in which the digital controller door 100 and the cooking appliance 1000 respectively include independent control components, and these control components cooperate with each other to control the function of the cooking appliance will be described.

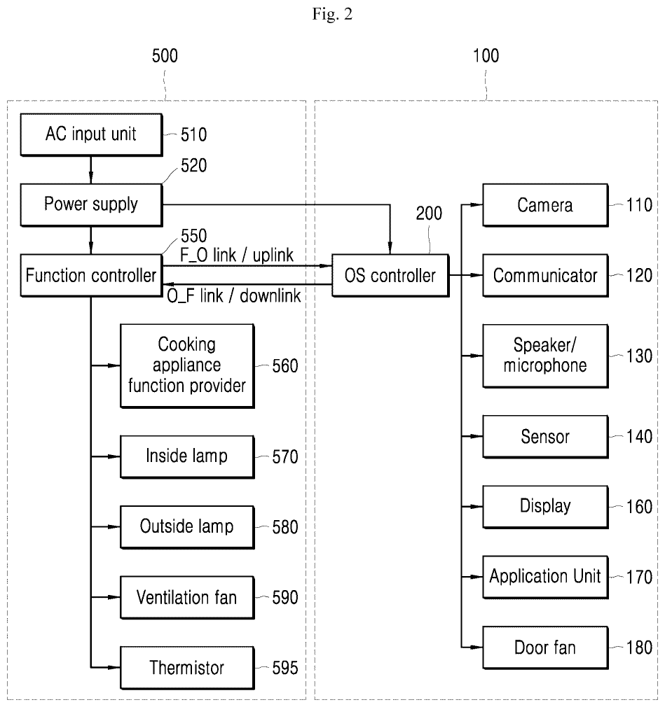

FIG. 2 is a diagram illustrating components of a digital controller door and components of a functional unit according to an embodiment of the present disclosure. Each of the components is conceptually disposed and is not limited to a specific physical location or material.

The digital controller door 100 (e.g., display door or smart display door, etc.) can operate as an Internet-of-things hub. The digital controller door 100 can include an operating system (OS) controller 200 (e.g., door controller). In addition, the digital controller door 100 can include a camera 110. In addition, the digital controller door 100 can include a communicator 120. In addition, the digital controller door 100 can include a speaker/microphone 130. In addition, the digital controller door 100 can include a sensor 140. In addition, the digital controller door 100 can include the display 160. In addition, the digital controller door 100 can include an application unit 170. In addition, the digital controller door 100 can include a door fan 180. The door fan can be embodied as a direct current (DC) fan and cools the heat of the digital controller door 100. In particular, the door fan 180 cools heat generated from the display 160.

Hereinafter, the OS controller 200 (e.g., door controller), the camera 110, the communicator 120, the speaker/microphone 130, the sensor 140, the display 160, the application unit 170, and the door fan 180 are referred to as elements or components of the digital controller door 100 (e.g., display door).

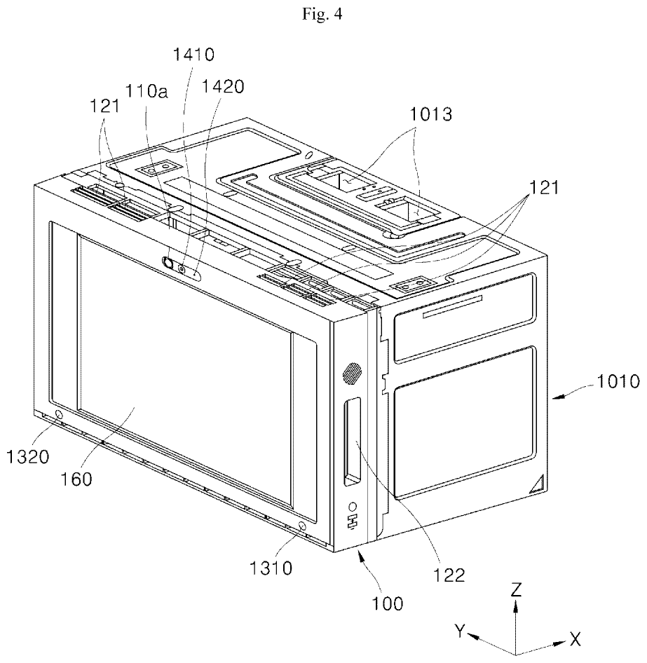

The functional unit 500 (e.g., main body or main portion) includes an AC input unit 510, a power supply 520, a function controller 550 (e.g., main controller or oven controller, etc.), a cooking appliance function provider 560 (e.g., magnetron, microwave generator, heater), an inside lamp 570, an outside lamp 580, a ventilation fan (vent fan) 590, etc. The functional unit 500 (e.g., main body) and the digital controller door 100 (e.g., smart door, or display door) are logically configured for the description of the present disclosure. The functional unit 500 (e.g., a main body or main portion of the cooking appliance) can be implemented as a body 1010 illustrated in FIG. 4. Accordingly, the functional unit 500 can further include various physical components for implementation as the body 1010 in addition to the components illustrated in FIG. 2. According to an embodiment, the functional unit 500 can be referred to as a main body or body portion of a microwave or a cooking appliance, and the digital controller door 100 can be referred to a display door, a smart door or touchscreen door of the cooking appliance.

The OS controller 200 (e.g., door controller) controls various components of the digital controller door 100 (e.g., display door). According to an embodiment, the OS controller 200 of the door can be referred to as a door controller, and the function controller 500 can be referred to as a main controller. According to embodiments, the function controller 500 and the OS controller 200 can be referred to in various ways, such as main controller and sub-controller, first controller and second controller, system controller and display controller, or main controller and user interface UI controller, or variations thereof. For example, the controller in the cooking appliance can be referred to as a function controller 550 or main controller and the controller in the door can be referred to as display controller. In addition, the OS controller 200 transmits a predetermined signal to the function controller 550, and allows the function controller 550 to control the performance of a specific function of the cooking appliance 1000. In addition, the function controller 550 (e.g., main controller) can transmit a signal to the OS controller 200 (e.g., door controller). This allows the function controller 550 to inform the OS controller 200 of a result related to the performance of a specific function of the cooking appliance 1000. The OS controller 200 can operate based on a specific OS (e.g., Android).

According to an embodiment, the function controller 550 and the OS controller 200 can operate independently and can communicate a predetermined signal with each other when there is information to be notified to each other. A type of signal can be based on various communication protocols such as wired communication or wireless communication. According to an embodiment, when the OS controller 200 receives information from the user and is instructed to perform a specific function of the cooking appliance, the OS controller 200 can transmit a specific signal to the function controller 550. In this situation, the function controller 550 operates the functional unit 500 (e.g., main body and components), for example, the body 1010.

The function controller 550 (e.g., main controller) can be embodied as a microcomputer for generating a signal for operating the functional unit 500, for example, the body 1010.

The camera 110 can be disposed on the digital controller door to photograph the outside of the cooking appliance 1000, photograph the surroundings, or photograph a cooking space inside the cooking appliance 1000.

In addition, the camera 110 can be disposed inside the digital controller door 100 (e.g., display door). The camera 110 can photograph the inside of the cooking appliance 1000 to allow the user to check the cooking state of the food stored therein.

Accordingly, the camera 110 can be disposed to face outwardly of the digital controller door 100 (toward the user) and to face inwardly of the digital controller door 100 (toward the inside of the cooking appliance). In this situation, the display 160 can output an image obtained by photographing the outside out of the cooking appliance or the inside of the cooking appliance based on the cooking state or a state of the function performed by the digital controller door 100.

The communicator 120 (e.g., communication interface, or transceiver) can perform various types of wired or wireless communication functions. The communicator can communicate with another device (e.g., an external server, a hub disposed in a home, or another home appliance) using a communication protocol such as Wi-Fi, BLUETOOTH, or the like.

The speaker/microphone 130 can generate a voice, an alarm sound, etc. for the operation of the cooking appliance 1000, and can receive a predetermined external voice command or an external sound. The speaker/microphone 130 can be integral with each other or can be disposed at different positions.

The sensor 140 senses an environment outside or inside the cooking appliance 1000. For example, the sensor 140 can include a temperature sensor, an illuminance sensor, a human sensor, a humidity sensor, etc.

The display 160 outputs visual information to be provided to a user. The information provided from the display 160 includes a cooking function or state of the cooking appliance 1000 in operation, an interface for controlling the cooking appliance 1000, and information on a surrounding environment in which the cooking appliance 1000 is disposed.

In addition, when the digital controller door 100 operates as an Internet-of-things hub, the display 160 can display various information in addition to cooking related information. In addition, the display 160 can convert a user's touch into an input signal.

The application unit 170 (e.g., memory) stores therein various application programs as executed by the digital controller door 100, and the OS controller 200 can execute the application programs stored in the application unit 170 and can display the execution results on the display 160. For example, the display 160 can be a touchscreen display.

The door fan 180 embodied as the direct current fan is configured to cool heat generated in various electronic devices related to a digital controller door. The door fan 180 can cool the heat generated from the display 160 or the OS controller 200.

The OS controller 200 can download various application programs through the communicator 120 and store and install the application programs in the application unit 170.

The application program according to an embodiment of the present disclosure includes an application program directly or indirectly related to the operation or function of the cooking appliance 1000, such as an application program for controlling the cooking of the cooking appliance 1000, an application program related to an image or a video to be displayed during the operation of the cooking appliance 1000, etc. In this situation, the OS controller 200 can control a function of the cooking appliance 1000 by controlling the function controller 550 using the application program.

In addition, the application program according to an embodiment of the present disclosure includes an application program for the digital controller door 100 to operate as the Internet of Things hub.

The AC input unit 510 of the functional unit 500 (e.g., main body portion) receives power required for the cooking appliance 1000 to operate. The supplied power is provided to the function controller 550 and the OS controller 200 through the power supply 520.

The function controller 550 (e.g., main controller) controls the functions of the cooking appliance 1000 (e.g., cooking, venting, turntable, lamp(s) etc.). In this regard, the function controller 550 receives a signal from the OS controller 200 and controls the functions of the cooking appliance 1000. The function controller 550 can control an operation of each of the cooking appliance function provider 560 (e.g., magnetron, microwave generator, heating coil(s), heater), the inside lamp 570, the outside lamp 580, the ventilation fan (Vent Fan) 590, and the thermistor 595 according to the signal received from the OS controller 200. Hereinafter, the cooking appliance function provider 560, the inside lamp 570, the outside lamp 580, the ventilation fan 590, and the thermistor 595 are referred to as elements or components of the functional unit 500.

The cooking appliance function provider 560 (e.g., magnetron, microwave generator, heating coil(s), heater) generates microwaves or heater heat to cook food stored in the cooking appliance 1000.

The inside lamp 570 is disposed inside the cooking appliance 1000 that is opened and closed by the digital controller door 100. When the digital controller door 100 is opened or closed, the inside lamp 570 can be turned on and off. Alternatively, when the cooking appliance 1000 is cooking the food, the inside lamp 570 can be turned on so that the internal camera can capture an image thereof.

The outside lamp 580 is disposed at a lower end or an upper end of the cooking appliance 1000. When the cooking appliance 1000 is disposed on top of a separate cooktop, the outside lamp 580 can be disposed at a lower end of the cooking appliance 1000.

The ventilation fan 590 discharges heat generated from the cooktop to the outside.

The thermistor 595 is a component disposed in the functional unit 500 (e.g., main portion including components) to sense a temperature. For example, the main portion can refer to the parts of the cooking appliance that do not include the display door. One or more thermistors 595 can be disposed at the cooking appliance 1000.

According to an embodiment of the present disclosure, the thermistor 595 can provide information on the sensed temperature to the function controller 550. According to another embodiment of the present disclosure, the thermistor 595 can be included in the sensor 140, and in this situation, information on the sensed temperature can be provided to the OS controller 200 that controls the sensor 140.

The food stored in the cooking appliance 1000 is cooked via the operation of the cooking appliance function provider 560. Even in this process, the function controller 550 and the OS controller 200 can communicate information with each other per a preset time interval.

The OS controller 200 provides a user interface/user experience (UI/UX) function. In addition, the OS controller 200 transmits a predetermined signal to the function controller 550, and the function controller 550 controls the operation of the cooking appliance 1000, for example, the body 1010 or the functional unit 500. In addition, the function controller 550 can control an operation of the cooking appliance function provider 560 and provide an information value generated therefrom during control to the OS controller 200.

Accordingly, the control flow of the OS controller 200 and the function controller 550 is configured such that the OS controller 200 transmits a predetermined signal to the function controller 550 and then receives a predetermined control result from the function controller 550. For example, the OS controller 200 in the door can monitor the function controller 550 in the body of the microwave/cooking appliance.

The OS controller 200 and the function controller 550 can communicate with each other in a wired or wireless manner. The OS controller 200 and the function controller 550 can communicate with each other using various communication protocols, and embodiments of the present disclosure are not limited to a specific communication protocol.

As illustrated in FIG. 2, a communication link via which the function controller 550 transmits predetermined data to the OS controller 200 or performs control is referred to as a F_O link or an uplink. A communication link via which the OS controller 200 transmits predetermined data to the function controller 550 or performs control is referred to as an O_F link or a downlink. However, embodiments of the present disclosure are not limited to a specific name or a direction such as upward/downward, and the links can be distinguished from each other based on a direction of data transmission between the components 550 and 200.

In an embodiment of the present disclosure, the link can physically use one or more lines or can use one or more communication media. In addition, in accordance with the present disclosure, a name is separately given to each data transmission direction in order to distinguish logically the data transmission directions from each other.

According to an embodiment of the present disclosure, in the situation of the wired communication, the OS controller 200 and the function controller 550 can communicate with each other using a communication protocol such as Universal asynchronous receiver/transmitter (UART) and Universal Serial Bus (USB).

According to an embodiment of the present disclosure, in the situation of the wireless communication, the OS controller 200 and the function controller 550 can communicate with each other using a communication protocol such as ZIGBEE, Wi-Fi, and BLUETOOTH.

Each of the OS controller 200 and the function controller 550 can include a separate memory (internal memory), and can store, in the memory, function result information or error information generated in the process of performing a function.

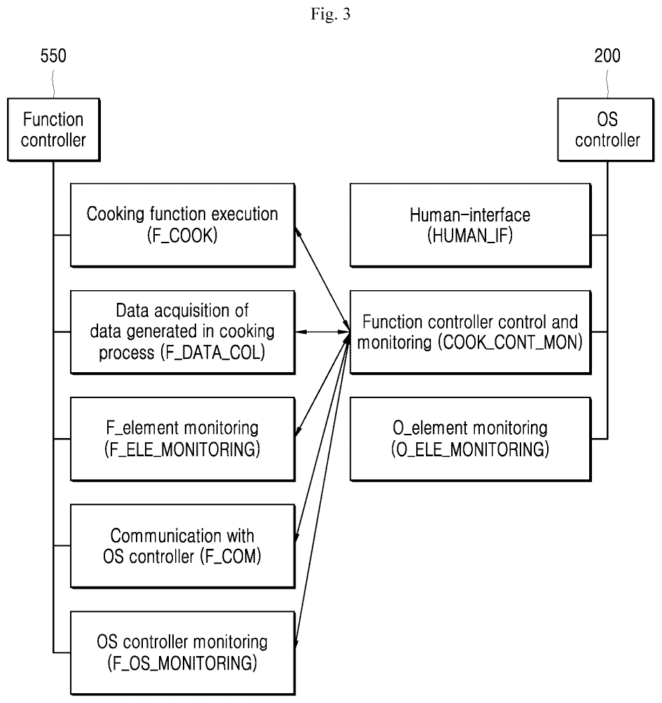

FIG. 3 is a diagram illustrating categories of functions performed by an OS controller and a function controller according to an embodiment of the present disclosure. Each function includes a situation in which each of the controllers 200 and 550 performs a corresponding function.

Each of the controllers 200 and 550 can perform the functions simultaneously or sequentially.

The function controller 550 controls the functional unit 500 that provides a cooking function. The operating system (OS) controller 200 transmits a signal to the function controller 550. The function controller 550 instructs an operation of the functional unit 500. The operating system (OS) controller 200 controls the digital controller door 100 that provides a human interface.

The functions performed by the function controller 550 include cooking function execution F_COOK. In addition, the functions performed by the function controller 550 include data acquisition F_DATA_COL of data generated in the cooking process. In addition, functions performed by the function controller 550 include F_element monitoring F_ELE_MONITORING. In addition, functions performed by the function controller 550 include communication F_COM with the OS controller 200. In addition, functions performed by the function controller 550 include OS controller monitoring F_OS_MONITORING. The OS controller 200 and the function controller 550 can operate independently, and can inform the state or operation status of each component via transmission and reception of signals to and from each other.

In the cooking function execution F_COOK, the function controller 550 controls the cooking appliance function provider 560 so that the cooking appliance 1000 can perform cooking. Alternatively, in addition to cooking such as heating, a function in which the function controller 550 controls the operation of the inside lamp 570, the outside lamp 580, and the ventilation fan 590 can be included in the cooking function execution F_COOK.

The function of the data acquisition F_DATA_COL of the data generated in the cooking process is a function of the function controller 550 collecting or acquiring various result values calculated by the elements or the components of the functional unit 500 or data related to the current state in the cooking function execution F_COOK process.

The F_element monitoring (F_ELE_MONITORING) refers to a function in which the function controller 550 monitors elements or components of the functional unit 500. The function controller 550 can monitor whether each element or component operates properly or whether each element or component operates according to a previous instruction to perform a function.

The communication F_COM function with the OS controller means that the function controller 550 provides data obtained in F_DATA_COL, F_ELE_MONITORING, etc. to the OS controller 200.

The OS controller monitoring F_OS_MONITORING function refers to a function in which the function controller 550 transmits a predetermined packet to the OS controller 200 to check whether the OS controller 200 is operating properly.

The F_COM and F_OS_MONITORING functions can be implemented as one function. That is, even when the cooking function is not performed, the function controller 550 transmits the data obtained through the F_ELE_MONITORING to the OS controller 200. The function controller 550 can check whether the OS controller 200 is in a normal state or an abnormal state based on whether the OS controller 200 has transmitted an acknowledgement (ACK) response to the transmitted data. For example, the normal state can refer to an error free operating state, and the abnormal state can refer to an operating state that includes one or more errors or problems.

The functions performed by the OS controller 200 include a human-interface HUMAN_IF. In addition, the functions performed by the OS controller 200 include function controller control and monitoring COOK_CONT_MON. In addition, the functions performed by the OS controller 200 include O_element monitoring O_ELE_MONITORING. In this regard, one embodiment of the function controller control and monitoring COOK_CONT_MON is that the OS controller 200 transmits a predetermined signal to the function controller 550 so that the function controller 550 can control the functional unit 500, that is, the body 1010.

The human-interface HUMAN_IF function refers to a function in which the OS controller 200 outputs a user interface, such as various information or a menu for controlling the cooking appliance, and receives a user's touch input or user command thereto.

One embodiment of the function controller control and monitoring COOK_CONT_MON is that the OS controller 200 provides a signal to the function controller 550 so that the function controller 550 controls the operation of the functional unit 500, that is, the body 110. In addition, one embodiment of the function controller control and monitoring COOK_CONT_MON is that predetermined information collected by the function controller 550, for example, information for monitoring the state or an operation status of the functional unit 500, that is, the body 110, is transmitted to the OS controller 200 in a form of a predetermined wired or wireless signal.

More specifically, when the user selects a specific cooking function in the human-interface HUMAN_IF function, the OS controller 200 can instruct the function controller 550 to execute the cooking function.

In addition, the OS controller 200 can perform monitoring to receive values of the operation states or cooking results of the elements or the components constituting the functional unit 500 from the function controller 550. All of these functions are included in the function controller control and monitoring COOK_CONT_MON. Accordingly, the function controller control and monitoring COOK_CONT_MON of the OS controller 200 is related to five functions of the function controller 550.

The O_element monitoring O_ELE_MONITORING refers to a function in which the OS controller 200 monitors the elements or the components of the digital controller door 100. The OS controller 200 can monitor whether each of the elements or the components operates properly, or whether each element or component operates according to a previous instruction to perform a function.

As shown in FIG. 3, the function controller 550 and the OS controller 200 perform respective given functions independently but in association with each other. Accordingly, the function controller 550 checks whether the OS controller 200 operates normally or not in the process of performing the function, while the OS controller 200 checks whether the function controller 550 operates normally or not in the process of performing the function. When an abnormality occurs in a component of one of the function controller 550 (e.g., main controller) and the OS controller 200 (e.g., door controller), the other of the function controller 550 and the OS controller 200 can cope with this situation or address the abnormality or error.

Hereinafter, a schematic outer appearance and configuration of a cooking appliance including the digital controller door 100 of the present disclosure will be described. This corresponds to one embodiment of the present disclosure, and a scheme and a direction in which the digital controller door 100 is opened can be implemented in various ways.

The present disclosure relates to a scheme for controlling a cooking appliance using a digital controller door disposed at a front surface of the cooking appliance.

According to the present disclosure, a door of a microwave oven disposed on top of an oven or a gas stove acts as an LCD screen (an embodiment of a display). The Android board (an embodiment of an OS controller) of the LCD screen and the microcomputer (an embodiment of a function controller) of the microwave oven cooperate with each other. An LCD component operates according to various operating/external environments of the microwave oven or controls a specific function of the microwave oven.

The digital controller door (e.g., display door, or smart door) of the present disclosure can be combined with the cooking appliance to open and close the inside of the cooking appliance. An embodiment of the cooking appliance of the present disclosure is a microwave oven. However, embodiments of the present disclosure is not limited thereto. An embodiment of the cooking appliance including the digital controller door of the present disclosure includes each of various cooking appliances which includes a door equipped with a display such as an LCD providing various user interfaces such as a touch screen, and is capable of storing and cooking food therein.

A display can be mounted on a front surface of a digital controller door provided in the cooking appliance of the present disclosure to provide various information to a user. The user can know the cooking state of the cooked food on the display.

In addition, when the display is connected to another home appliance to serve as a hub of the home appliances, the information other than cooking food can be obtained through the display. In addition, a command for cooking and various other commands can be input to the display in a touch manner.

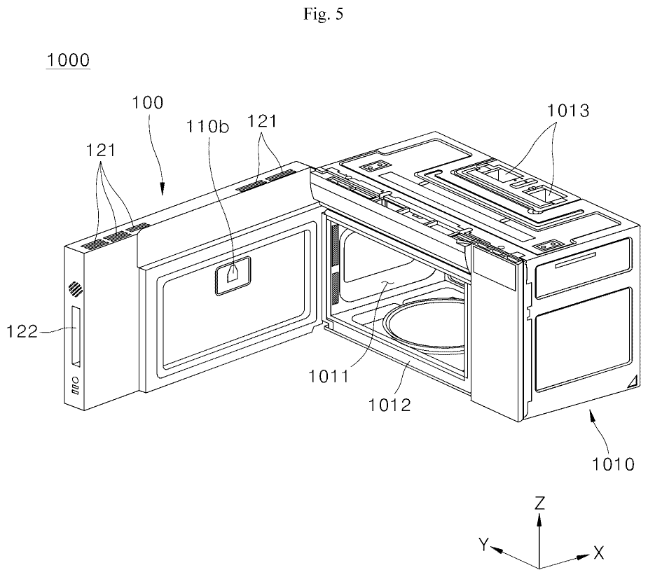

FIG. 4 is a perspective view illustrating a cooking appliance according to an embodiment of the present disclosure. FIG. 5 is a diagram illustrating a state in which the digital controller door 100 is opened in FIG. 4.

According to an embodiment of the present disclosure, the sensor 140 of FIG. 2 is implemented as an illuminance sensor 1410 and an infrared sensor 1420. The illuminance sensor 1410 disposed next to the camera 110a detects light in a space in which the cooking appliance 1000 is disposed, for example, illuminance of the kitchen. The infrared sensor 1420 disposed next to the illuminance sensor 1420 detects a person near the cooking appliance 1000.

The sensor 140 according to another embodiment of the present disclosure can be disposed in another area of the digital controller door 100.

The cooking appliance according to the embodiment can be disposed at a position spaced apart from the heating cooking device in the vertical direction above a position where a heating-type oven, a gas stove, etc. are disposed.

Due to the arrangement of the cooking appliance, a user can conveniently use the heating cooking device including the cooking appliance. In addition, the cooking appliance can serve as a hood of the heating cooking device disposed under the cooking appliance. In this situation, the cooking appliance can include components for use as the hood.

The cooking appliance can cook food using microwaves belonging to electromagnetic waves and/or heater heat. The cooking appliance can include the body 1010 in which a cavity 1011 is formed, and the digital controller door 100 configured to open and close the cavity 1011. The body 1010 is an embodiment of the functional unit 500 of FIG. 2 as described above. According to an embodiment of the present disclosure, the body 1010 can act in the same manner as the functional unit 500 can. Alternatively, according to an embodiment of the present disclosure, the components of the functional unit 500 can be implemented in the body 1010. Accordingly, in various embodiments, the functional unit 500 and the body 1010 can be interchangeable with each other.

Food to be cooked can be placed in the cavity 1011. The digital controller door 100 can be disposed in front of the cavity 1011 and pivotally mounted at the body 1010 to open and close the cavity 1011.

A ventilation hole 1013 for discharging air suctioned from a suction unit provided at a lower portion of the body 1010 to the outside can be provided at an upper portion of the body 1010. A suction unit can be provided at a lower portion of the body 1010 of the cooking appliance. Accordingly, the cooking appliance can serve as a hood that sucks air discharged from the heating cooking device disposed below the cooking appliance and discharges the air to the outside.

The body 1010 can further include a front panel 1012 provided along an edge of an inlet of the cavity 1011. One surface of the front panel 1012 faces one surface of a choke member when the digital controller door 100 is closed, thereby closing the cavity 1011.

The front panel 1012 can be constructed to surround the edge of the inlet of the cavity 1011 and protrude in a frontward direction and has a predetermined width. Accordingly, when the digital controller door 100 is closed, the edge portion of the digital controller door 100 and the cavity 111 can overlap each other.

Due to this structure, the front panel 1012 can seal the cavity 1011 in a state in which the digital controller door 100 has been closed, thereby preventing oil, moisture, oil vapor, etc. generated during the cooking process of the food placed in the cavity 1011 from being leaked out to the outside through the inlet of the cavity 1011.

In the structure of FIG. 4, the speaker 1310 and the microphone 1320 which are components of the speaker/microphone 130, can be disposed at the lower end of the digital controller door 100. However, the present disclosure is not limited to such a specific position, and the speaker 1310 and the microphone 1320 can be disposed in various areas of the digital controller door 100.

In addition, the speaker 1310 can include at least one speaker. The microphone 1320 can include at least one microphone.

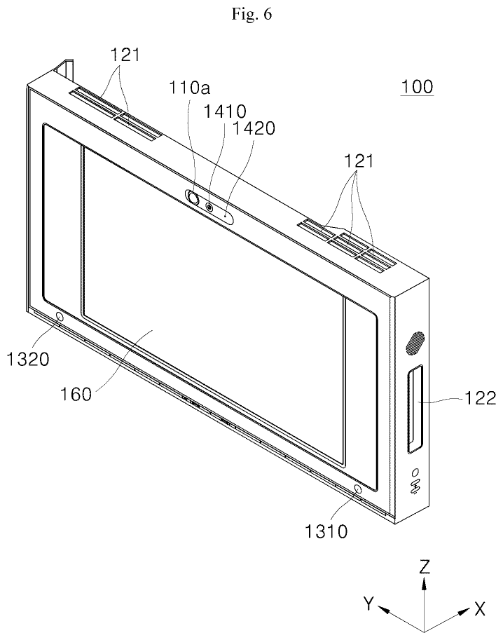

FIG. 6 is a perspective view illustrating a digital controller door (e.g., display door) of a cooking appliance according to an embodiment of the present disclosure.

The digital controller door 100 can include controller hardware (e.g., a hardware chip) or controller software (software including programs) that executes a predetermined algorithm and performs following tasks based on sensing results from various sensors disposed at the cooking appliance or the door and an operating state of the cooking appliance.

In FIGS. 4 to 6, a reference numeral 121 denotes a through hole through which air is introduced or discharged. A first camera 110a and the sensor 140 can be disposed on the front surface of the digital controller door 100. The sensor 140 includes a human sensor, an illuminance sensor, etc.

The display 160 is used to control the cooking appliance 1000 or displays an operation process in the cooking appliance 1000. The ventilation hole 1013 can include a suction portion defined at a lower end of the body 1010 and a discharge portion defined at an upper end of the body 1010. A handle 122 is disposed on one side of the digital controller door 100 such that the user can open and close the digital controller door 100 using the handle.

A second camera 110b can be disposed on an inner side surface of the digital controller door 100, and the second camera 110b can photograph the inside of the cavity 1011 to check the cooking state.

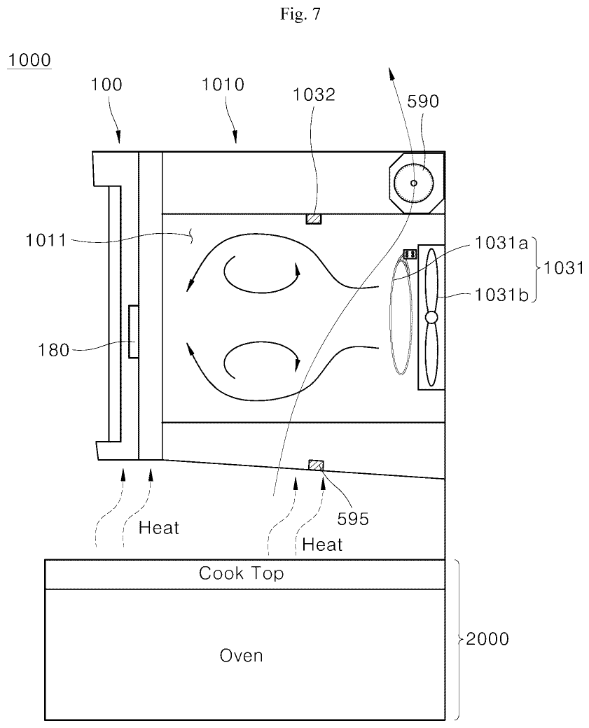

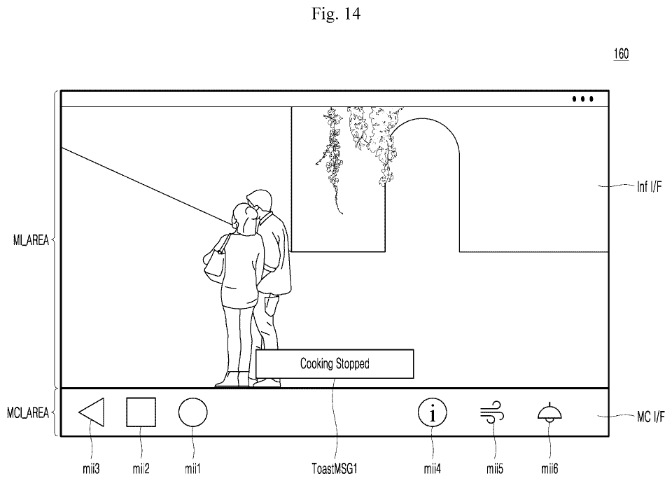

FIG. 7 is a schematic view illustrating a position where a cooking appliance is disposed according to an embodiment of the present disclosure. In FIG. 14, the flow of air is indicated by a solid line arrow, and the transfer direction of heat is indicated by a hidden line arrow. A heating cooking device 2000 can include, for example, an oven and a cooktop disposed on top of the oven.

The cooking appliance can include a convection-based heating device 1031 and a microwave generating device 1032 to heat food accommodated in the cavity 1011.

The convection-based heating device 1031 can generate heat to heat food, and the microwave generating device 1032 can generate microwaves to heat food. The user can select and operate one of the convection-based heating device 1031 or the microwave generating device 1032 to heat and cook food.

The convection-based heating device 10 31 can include a convection heater 1031a and a convection fan 1031b. The convection heater can generate heat to heat food accommodated in the cavity 1011. The convection fan 1031b can force the air in the cavity 1011 heated by the convection heater 1031a to flow in the cavity 1011.

When the convection fan 1031b operates, the heated air can be smoothly convectively circulated in the cavity 1011, and accordingly, heat is uniformly supplied to an entirety of the cavity 1011, so that an entirety of the food accommodated in the cavity 1011 can be evenly cooked.

In order to prevent the display 160 provided in the digital controller door 100 from being overheated by the heated air coming up from the heating cooking device disposed under the cooking appliance, resulting in malfunction of or damage to the display 160, it is advantageous to cool the display 160 and prevent external heat from being transferred to the display 160. The door fan 180 and the ventilation fan 590 can perform the above role.

The door fan 180 can be disposed inside the digital controller door 100 (e.g., the door fan can be inside the smart display door). The door fan 180 can effectively cool the display 160 by flowing air toward the rear surface of the display 160.

In addition, the air flow discharged from the door fan 180 to the outside of the digital controller door 100 (e.g., display door) can form an air curtain to block the heat rising from the heating cooking device disposed under the cooking appliance.

The ventilation fan 590 can be disposed at a top of the body 1010 and can be disposed in a flow path of the ventilation hole 1013. The ventilation fan 590 can allow air coming up from the heating cooking device to flow to the ventilation hole 1013 to discharge the air to out of the cooking appliance.

Accordingly, when the ventilation fan 590 operates, a significant portion of the heated air coming up from the heating cooking device flows to the ventilation hole 1013 formed in the body 1010, and the flow rate of air heading to the display 160 of the digital controller door 100 (e.g., display door) can be relatively reduced. As a result, the flow rate of the heated air directed to the display 160 of the digital controller door 100 is reduced, thereby suppressing overheating of the display 160.

In order to block overheating of the display 160, it can be advantageous to appropriately use the door fan 180 and the ventilation fan 590. Since one of main purposes of the door fan 180 is to prevent the overheating of the display 160, the door fan 180 can operate in a low-speed rotation mode and a high-speed rotation mode based on the temperature condition of air approaching the digital controller door 100.

The door fan 180 has a small amount of air blown in the low-speed rotation mode and a large amount of air blown in the high-speed rotation mode. Therefore, the temperature of the display 160 can be effectively lowered by the door fan operating in the low-speed rotation mode when the temperature of the air is low and by the door fan operating in the high-speed rotation mode when the temperature of the air is high.

In order to reliably suppress the overheating of the display 160, it is advantageous to operate both the door fan 180 and the ventilation fan 590 and operate the door fan 180 in the high-speed rotation mode.

The thermistor 595 disposed at a bottom of the cooking appliance 1000 can sense the heat from the heating cooking device disposed under the cooking appliance 1000. In addition, the auto ventilation function can operate upon sensing the heat.

In the embodiment of FIG. 7, the outside lamp 580 can emit light toward the lower end. For example, when the user touches the digital controller door 100, the outside lamp 580 can be turned on. Alternatively, when a movement of a person is identified and ambient illuminance is lower than or equal to a predetermined reference (e.g., illuminance 10 lux or lower), the outside lamp 580 can be turned on under the control of the OS controller 200 (e.g., door controller).

In addition, the door lamp 195 can be disposed at a lower end of the digital controller door 100. For example, when a user touches the digital controller door 100, the door lamp 195 can be turned on. Alternatively, when a movement of a person is identified and ambient illuminance is lower than or equal to a predetermined reference (e.g., illuminance 10 lux or lower), the door lamp 195 can be turned on under the control of the OS controller 200 (e.g., door controller).

According to an embodiment of the present disclosure, the outside lamp 580 can be controlled by the function controller 550. In this situation, the OS controller 200 can instruct the function controller 550 to turn on/off the outside lamp 580.

According to another embodiment of the present disclosure, the outside lamp 580 can be directly controlled by the OS controller 200 (e.g., door controller). In this situation, the outside lamp 580 can be disposed in the functional unit 500 (e.g., main portion), but can be controlled by the OS controller 200 (e.g., door controller) of the digital controller door 100 (e.g., display door).

The digital controller door 100 (e.g., display door) can receive a user's command via a touch input to the display 160 and control the cooking appliance 1000 based on the command. In addition, the digital controller door 100 (e.g., display door) can control the cooking appliance 1000 based on a voice command input through the microphone 1320. That is, the microphone 1320 receives a user's voice, and the speaker 1310 outputs a predetermined sound. The display 160 outputs an image. Accordingly, the digital controller door 100 (e.g., display door) can provide a human interface.

The OS controller 200 (e.g., door controller) can provide the human interface (e.g., a user interface) related to a task performed by the cooking appliance 1000. The human interface provided from the OS controller 200 (e.g., door controller) can be output to the display 160, and the display 160 can receive a touch input from the user.

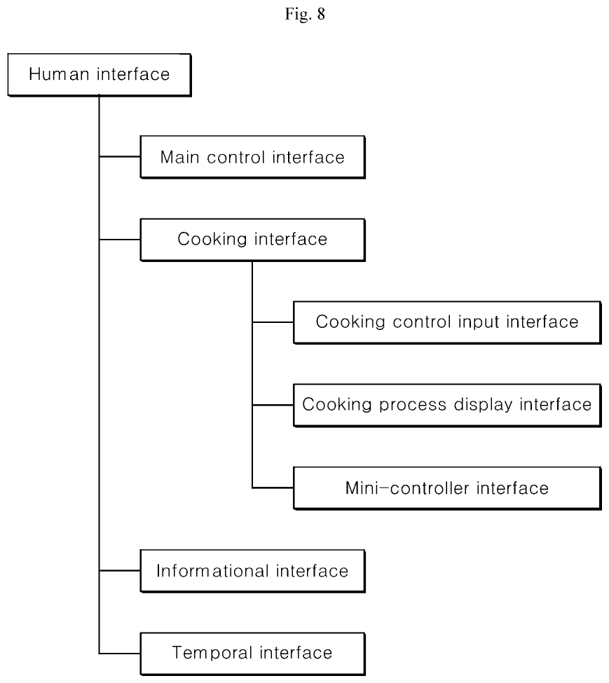

FIG. 8 is a diagram illustrating a configuration of classifying a human interface according to an embodiment of the present disclosure. Hereinafter, the interface refers to a human interface, that is, a user interface (UI).

The human interface can be classified into a main control interface (e.g., abbreviated as MC I/F), a cooking interface (e.g., abbreviated as Cook I/F), an informational interface (e.g., abbreviated as Inf I/F), and a temporal interface (e.g., abbreviated as Temp I/F).

The main control interface MC I/F is an interface that can always be provided by the OS controller 200 (e.g., door controller) and can always be displayed at a specific position of the display 160, but embodiments are not limited thereto. The main control interface is an interface that allows an interface for checking various interfaces provided by the digital controller door 100 or invoking an interface for controlling cooking.

For example, the main control interface MC I/F can include a home button for processing a user's touch input, a back button for moving to a previous menu, and a main stop button for stopping an operation of a currently executed specific function. Alternatively, the main control interface MC I/F can include only a home button.

The main control interface MC I/F can be fixed at and displayed in a specific area of the display 160. Alternatively, the main control interface MC I/F displayed on a first area of the display 160 can be set to be displayed on a second area of the display 160 according to a user's setting.

The cooking interface Cook I/F indicates a cooking state when the cooking appliance 1000 performs a predetermined cooking function and provides an input interface that the user can control for the related cooking (e.g., start, stop, add time, time remaining, power level status, turntable status, etc.). The cooking interface CI can be subdivided into a cooking control input interface and a cooking process display interface. In addition, an interface indicating a cooking state displayed in a reduced form is referred to as a pop-up interface or notification message interface (e.g., abbreviated as a pop-up) or a mini-controller interface (e.g., abbreviated as a mini-controller). The mini-controller is provided when exiting the cooking interface during cooking. During cooking, either the cooking interface or the mini-controller interface may be displayed.

The cooking control input interface includes an input interface that the user can touch so that the user can instruct the start of cooking or pause or stop the progress of cooking.

The cooking process display interface is an interface indicating a state in which cooking is in progress.

The informational interface Inf I/F is an interface that displays a specific background screen set by a user, displays information transmitted from an external source (e.g., movie playback, streaming video, video chat, etc.), or allows a user to perform web surfing.

When the informational interface Inf I/F outputs predetermined information and the user touches a specific area to check the specific information in detail, the OS controller 200 (e.g., door controller) can activate a link URL disposed in the touched area and output new information to the display 160.

The temporary interface Temp I/F is an interface that temporarily displays information to inform the user of specific information (e.g., a temporary notification or pup-up, etc.). The temporary interface can automatically disappear after displaying information for a predetermined time duration (e.g., 5 seconds or 10 seconds, etc.). In addition, when the user touches the information displayed on the temporary interface or touches an “OK” button displayed in the information, the displayed information can disappear. In an embodiment, a toast message is included in the temporary interface (e.g., FIG. 14).

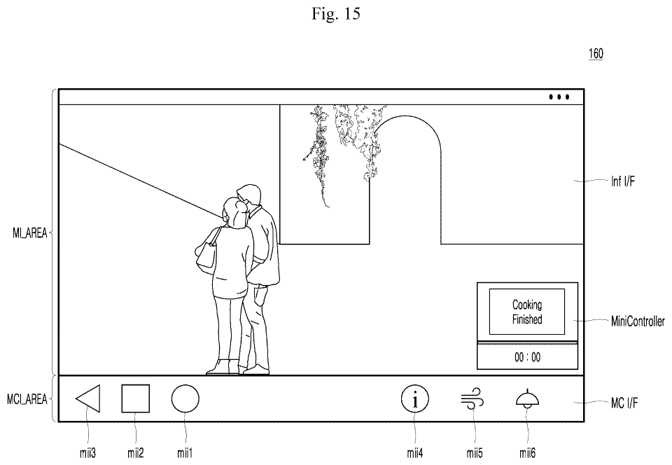

An area of the cooking interface displayed while the cooking is being performed can be minimized (e.g., FIG. 15). The minimized cooking interface can be disposed in a partial area of the informational interface (e.g., a lower corner area). The cooking interface can be minimized according to the user's touch or drag manner, and the minimized cooking interface (e.g., the mini-controller interface) can be disposed at various positions of the display 160.

The informational interface may not be output from the display 160 when the user touches the back button of the main control interface.

Hereinafter, in an embodiment of pressing a button or selecting a button, a user touches an image in a form of a button displayed on the display 160.

When the interface structure of FIG. 8 is applied, the cooking appliance including the digital controller door can provide a user experience (UX) for displaying a cooking progress screen in a cooking process.

That is, the digital controller door 100 controls a UX (e.g., a cooking interface) for displaying a cooking progress screen. According to an embodiment, when the user exits the UX by pressing the home button (e.g., home key) displayed on the digital controller door, each of the existing cooking progress screen and the existing control screen can be reduced in size to be displayed as a small screen. The cooking progress screen and the control screen may not be removed in this situation, but can be continuously maintained while the cooking is in progress, and thus the efficiency of the user interface can be increased and safety can be enhanced.

The cooking appliance 1000 including the digital controller door 100 (e.g., display door) can display the cooking state of the cooking appliance on the display (e.g., LCD screen) 160. In an embodiment, an inside picture can be taken using a camera inside the cooking appliance, and a current cooking situation (e.g., a situation in which the cooking is performed compared to an entire cooking time duration period, etc.) can be displayed based on the image.

The digital controller door (e.g., display door) can output an interface indicating the cooking state on an entirety of the display 160.

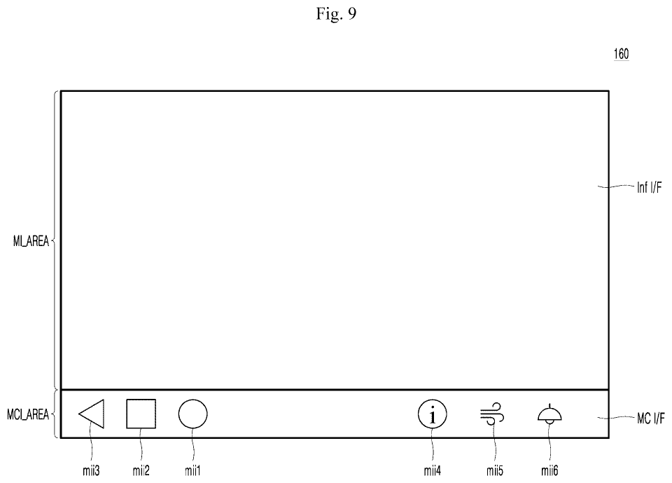

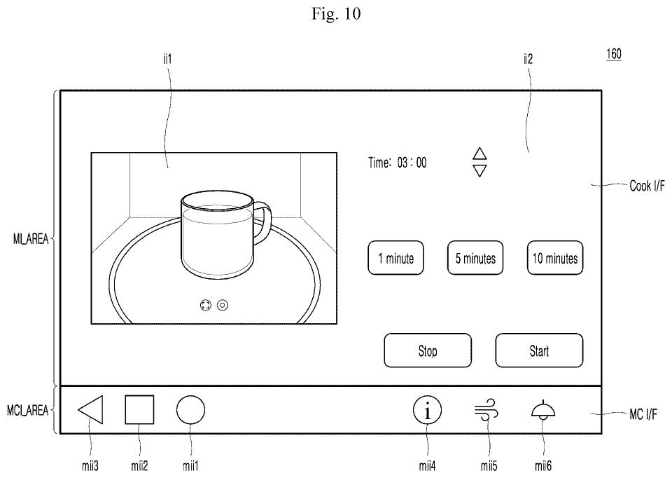

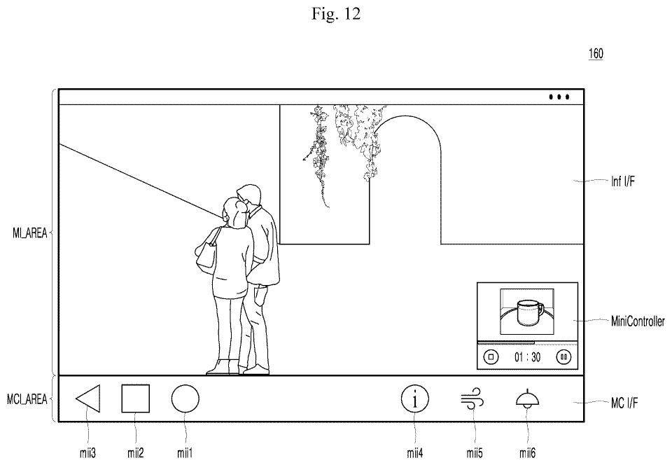

The entire display is divided into two areas. The main interface area MI_AREA is an area in which the Inf I/F of FIG. 9, which will be described later, is disposed, the Cook I/F of FIG. 10 is disposed, or the MiniController of FIG. 12 is disposed. Alternatively, the temporal interface can also be disposed in the main interface area. This refers to FIGS. 9, 10, 11, 12, 14, 15, 16, and 23.

The main control interface area MCI_AREA is an area in which the main control interface MC I/F is disposed in FIGS. 9 to 12 (e.g., a menu in the form of a). This refers to FIGS. 9, 10, 11, 12, 14, 15, 16, and 23.

FIG. 9 is a diagram illustrating an example of a human interface according to an embodiment of the present disclosure. This is an embodiment in which the main control interface MC I/F is displayed in a lower end area of the display 160. In addition, in an area on top of the main control interface MC I/F, the informational interface Inf I/F can output various information. For example, the main control interface MC I/F can be referred to as a menu bar, a navigation bar, a home bar, or quick settings bar, and can be located at the top of the display, a side of the display or the bottom of the display, but embodiments are not limited thereto.

In one embodiment, the informational interface Inf I/F includes a background screen set by the user. In addition, in another embodiment, the informational interface includes a web search screen or a screen on which a video is displayed. For example, the informational interface Inf I/F can be referred to as a display area, a viewing area, a main content area, a player window, or a viewport, and can be located at a central portion of the display, but embodiments are not limited thereto.

In the embodiment of FIG. 9, the main control interface MC I/F is disposed in the lower end area of the display 160 (e.g., a home bar or navigation bar at the lower side of the display). However, embodiments of the present disclosure are not limited thereto, and the main control interface MC I/F can be disposed in an upper end area or a left or right side area of the display 160.

The main control interface MC I/F can include interfaces such as a back button mii3, a home button mii2, and an off button mii1.

The back button mii3 is a button that is pressed to allow a current interface to switch to a previous step or a previously displayed interface. The home button mii2 shows a preset main menu (e.g., home menu, or home screen), and the user can set various information in the main menu.

The off button mii1 can instruct an operation of turning off or restarting the digital controller door 100. In addition, the off button mii1 can instruct an operation of turning off or restarting the display 160 (e.g., turn off only the display of the display door). Alternatively, the off button mii1 can instruct an operation of turning off or restarting an entirety of the cooking appliance 1000 (e.g., full shut down).

In addition, the main control interface MC I/F can include an interface such as a help button mii4 for a help, a button mii5 for controlling or showing an operation state of the ventilation fan 590, and a button mii6 for turning on/off the outside lamp 580.

The informational interface Inf I/F can display an image set by the user or a search screen, information for the user, etc. When the cooking of the cooking appliance is to be controlled, the cooking interface Cook I/F can be displayed instead of the informational interface Inf I/F so that the cooking appliance 1000 can be controlled via a user's manipulation thereon.

The main control interface, according to an embodiment of the present disclosure provides an interface for controlling the operation of each of the ventilation fan 590 and the outside lamp 580. The user can repeatedly touch the mii5 to turn on or off the operation of the ventilation fan 590 or increase or decrease the operation level of the ventilation fan 590.

In addition, when the auto ventilation operates, the operating state of the ventilation fan 590 can be displayed on the main control interface.

When the thermistor 595 detects the temperature, the ventilation fan 590 can automatically operate based on the temperature detection. This is referred to as the auto ventilation. The function controller 550 (e.g., main controller) can automatically activate the auto ventilation function based on the temperature sensed by the thermistor 595 to prevent component failure or damage. That is, the function controller 550 can activate the auto-ventilation function when it is determined that the temperature of the thermistor is equal to or higher than a predetermined temperature, and accordingly, may notify the OS controller 200 (e.g., door controller) of information indicating that the auto-ventilation function is being activated.

In response to reception of the notification, the OS controller 200 (e.g., door controller) can display an auto ventilation operation state on the display 160.

The OS controller 200 (e.g., door controller) can display, on the display 160, a pop-up message indicating that the auto ventilation is being activated when the temperature sensed by the thermistor 595 reaches a predetermined temperature condition. This is a function that the user may not cancel or change arbitrarily. Accordingly, the OS controller 200 can display information indicating that the auto ventilation operation is being performed on the display 160 and can also output a message indicating that the auto ventilation operation cannot be changed or cancelled. The user may not set a timer for this auto ventilation operation. The ventilation fan 590 is terminated when the auto ventilation has been terminated even though the user turns off the cooking appliance 1000 on the display 160.

In addition, the auto-ventilation can be executed when a timer is set. In this situation, the OS controller 200 (e.g., door controller) can display a remaining timer time on the display 160 when the auto-ventilation operation has been terminated. In addition, when the auto-ventilation operation ends and the timer time ends, the ventilation fan 590 is also turned off.

In one example, when the user starts to operate the ventilation fan 590 during the cooking, an operation intensity of the ventilation fan 590 may not be set to a turbo level (e.g., strong intensity). After the cooking has been finished, the ventilation fan 590 can operate in the turbo level as long as the previously set ventilation fan intensity is the turbo level.

As described above, the auto ventilation function refers to a function provided to protect components of the cooking appliance 1000. Accordingly, when an error occurs in a process in which the function controller 550 (e.g., main controller) cooperates with the OS controller 200 (e.g., door controller), the operations of other components of the functional unit 500 (e.g., main portion) can be canceled, but the operation of the ventilation fan 590 executing the auto ventilation can be maintained. Similarly, even when there is no instruction from the OS controller 200 (e.g., door controller), the function controller 550 (e.g., main controller) can automatically start or end the operation of the ventilation fan 590 based on the temperature sensed by the thermistor 595.

Accordingly, when the auto ventilation is being executed, the OS controller 200 (e.g., door controller) can display the auto ventilation situation in the area of mii5 among the areas of the main control interface of FIG. 9.

The OS controller 200 (e.g., door controller) can change the color of the wind displayed on the mii5 or the size of the image to indicate the flow or intensity of the wind of the ventilation fan 590.

In addition, a control lock can be set to prevent the user from manipulating the human interface in the auto-vent situation.

When the control lock function is activated (e.g., turned on), the interfaces of the display 160 are locked and the touch thereon is not activated, and the function operation of the ventilation fan or the lighting can be restricted. For example, the OS controller 200 (e.g., door controller) can control an entirety of the screen of the display 160 to be darkened and display an image such as a lock thereon, thereby displaying that the user cannot control the cooking appliance 1000 through the display 160.

In addition, the OS controller 200 (e.g., door controller) can display a button interface allowing the user to be capable of “unlocking” the control lock after the control lock has been activated on the display 160. Thus, when the user presses the “unlock” button for a predetermined time duration (e.g., 3 seconds), the locking of the input such as the touch onto the display 160 can be released.

Upon exiting the application displayed on the display 160 in the control lock state, the locked state can be maintained when re-executing the application later.

In response to that the ventilation fan 590 or the outside lamp 580 is in use, the control lock setting can be dimmed (e.g., darkened), and a setting guide message can also be changed.

FIG. 10 is a diagram in which a cooking interface according to an embodiment of the present disclosure is displayed. FIG. 10 illustrates a state in which a user has put an object (e.g., a water cup or mug) containing a material to be cooked into the cooking appliance 1000 and then has closed the digital controller door 100. Also, screen portion or area ii1 is an image captured by the second camera 110b inside the digital controller door 100. That is, the screen portion ii1 can display an image or a video obtained by capturing the inside of the cavity 1011, and can identify the object (e.g., the cup) containing the material to be cooked into which the user has put.

Screen portion or area ii2 is an interface for setting a cooking time duration of the cooking appliance 1000, and refers to an embodiment of the cooking control input interface. The user can adjust the cooking time duration by selecting 1 minute, 5 minutes, 10 minutes, etc. or pressing an upper or lower triangle.

When the user presses the “Start” button, the OS controller 200 (e.g., door controller) can control the function controller 550 (e.g., main controller) so that the cooking appliance 1000 starts cooking according to a set time duration (e.g., 3 minutes). In addition, when the user presses the “Stop” button, the OS controller 200 (e.g., door controller) can set the time setting to 0 and can control the interface so that the user can set the cooking time duration again.

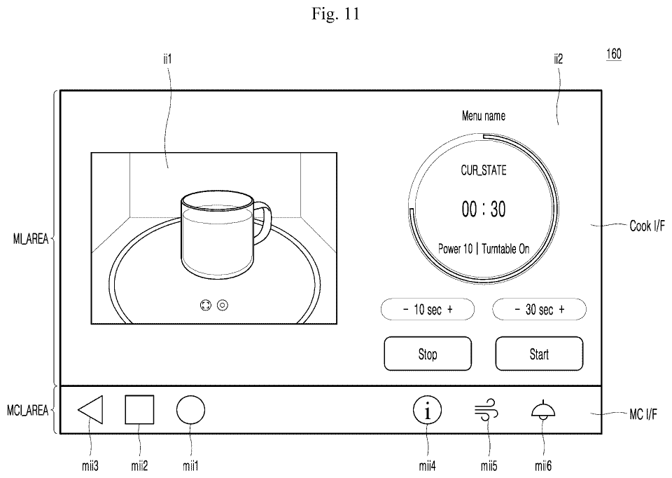

FIG. 11 is a diagram in which a cooking interface according to another embodiment of the present disclosure is displayed. FIG. 11 illustrates a state in which a user has put an object (e.g., the water cup or mug) containing the material to be cooked into the cooking appliance 1000 and then has closed the digital controller door 100. This state is the same as in FIG. 10.

The user can increase or decrease the cooking time duration displayed on area ii2 on a 10 seconds or 30 seconds basis. Alternatively, the screen area ii2 can correspond to an interface in which a time duration which has elapsed in the cooking process starting after the user sets the cooking time duration and then presses the “Start” button as in FIG. 10 is displayed as “00:30” and the user can add or subtract a time to or from a currently set cooking time duration.

A marking marked as CUR_STATE refers to a current state of cooking. When the user has set the time duration and then has selected the button “Start” in FIG. 10, the CUR_STATE can be displayed as “Cooking.” When the user has selected the “Stop” button, the CUR_STATE can be displayed as “Paused” indicating that cooking is temporarily stopped (paused).

Screen area ii2 of FIG. 11 can correspond to one embodiment of a cooking process display interface. The remaining time duration as the cooking progresses can be displayed in the area ii2. In addition, the screen region ii1 of FIG. 10 shows a change in the input food or material while the cooking is performed, and thus can correspond to an embodiment of the cooking process display interface.

FIG. 10 or 11 shows a state in which the cooking interface is output on an entirety of the display 160 of the digital controller door 100. In FIGS. 10 and 11, on the left side (e.g., indicated by screen region ii1), an image or a video captured by a camera mounted inside the cooking appliance is displayed.

In FIGS. 10 and 11, a right side (e.g., screen area ii2) displays a menu or function or a cooking time duration as currently selected for the cooking, and displays an interface (e.g., Timer) for displaying the cooking time duration and increasing or decreasing the cooking time duration, and an interface for stopping in (e.g., STOP) or pausing (e.g., PAUSE) the cooking.

Each of FIGS. 10 and 11 shows a basic configuration of the cooking interface. While the cooking is in progress, an interface as shown in each of FIGS. 10 and 11 can be displayed on the screen. When the user presses the home button mii2 while the cooking is in progress (or when the user presses another key such as a back button/back key), the informational interface can be output and the cooking interface can be changed to a pop-up interface. For example, the main interface area MI_AREA can be switched from the cooking interface to a browser window or content player interface, with the mini-controller overlaid thereon (e.g., picture-in-picture mode for watching entertainment content while also being able to monitor the cooking status and control).

FIG. 12 is a diagram showing an informational interface and a cooking interface according to an embodiment of the present disclosure.

When the user touches a specific button (e.g., mii2 or mii3) of the main control interface MC I/F while the cooking is performed in the state of FIG. 10 or 11, the informational interface including, for example, a background screen set by the user as shown in FIG. 12 is displayed on the display 160. In addition, the mini-controller interface can be displayed to indicate that the cooking in FIG. 10 or 11 is in progress.

FIG. 12 is a diagram illustrating a state in which an interface related to a cooking state has been changed to the pop-up interface or picture-in-picture view, that is, the mini-controller interface, according to an embodiment of the present disclosure

FIG. 12 is a diagram showing the informational interface Inf I/F including, for example, a background screen when a user presses a back button/back key mii3 or a home button or a home key mii2 in a state in which cooking has been started in FIG. 10 or FIG. 11. In addition, the mini-controller interface as a pop-up interface indicating the current cooking state is displayed at a lower end of a lower right of the interface, but embodiments are not limited thereto and the mini-controller interface can be displayed at other areas of the display screen.

Compared with FIG. 11, the pop-up interface as one example of the mini-controller interface (e.g., indicated by MiniController) can display an image or a video obtained by capturing the inside of the cooking appliance, or an image indicating a state in which cooking is being performed (e.g., video-in-video can be provided).

In addition, an interface in which a time duration for which the cooking has been performed is displayed and which is used to stop or pause the cooking can be displayed, so that the user can stop or end the cooking. While the cooking is in progress, the mini-controller interface such as a pop-up interface can be executed, and a notification icon can be displayed on a status bar.

In the state of FIG. 12, when the user touches an area other than a specific button on the screen of the digital controller door, the cooking state interface as shown in FIG. 11 can be displayed again (e.g., the view in FIG. 11 can be restored or maximized).

FIG. 12 is summarized as follows.

The informational interface is an interface that displays information not related to cooking of the cooking appliance. In one embodiment, the informational interface can include the background screen preset by the user or an information search screen. An embodiment of the information not related to cooking of the cooking appliance includes any one or more of an image or video set as a background, a wallpaper image, photo album slide show, a video or movie, a TV image, a web search screen, or an executed screen of an application program installed in the application unit 170.

In addition, when the cooking is being performed in the cooking appliance 1000, the OS controller 200 (e.g., door controller) can display the mini-controller interface in a first area of the display 160 on which the informational interface is displayed. For example, when the user performs a touch input on the cooking interface to start the cooking (“Start” button touch), the OS controller 200 (e.g., door controller) can display that the cooking is started, and then output the informational interface and display the mini-controller interface.

The user can adjust the position of the mini-controller interface in a drag manner. When a drag input occurs after touching the mini-controller interface, the OS controller 200 can change a position of the mini-controller interface in response to the drag input. The OS controller 200 (e.g., door controller) stores therein information about the position to which the mini-controller interface has moved in response to the drag input. Thereafter, the OS controller 200 (e.g., door controller) can display the mini-controller interface with reference to the stored position information.

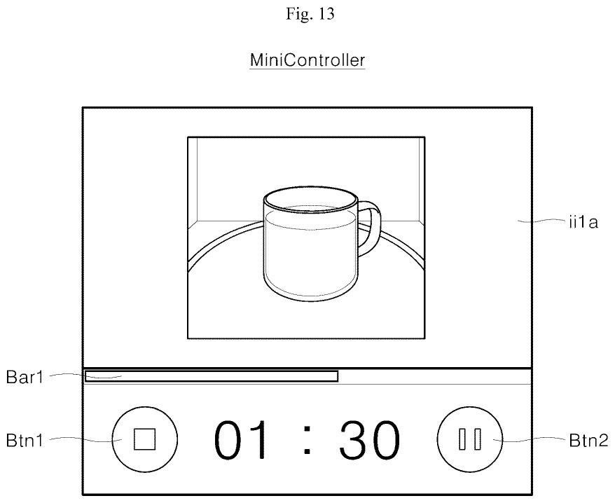

FIG. 13 is a diagram illustrating a configuration of a mini-controller interface according to an embodiment of the present disclosure. The mini-controller interface includes a display area (e.g., screen region ii1a) in which an image or a video of an object containing a material to be cooked is displayed, a progress bar (e.g., indicated by Bar1) indicating a progress state of the cooking process, a stop button (e.g., indicated by Btn1) for ending the cooking, and a pause button (e.g., indicated by Btn2) for pausing the cooking.

A size of the mini-controller interface can increase or decrease under the control of the user. In response thereto, a size of each of the buttons, a size of the progress bar, and a size of the image or video obtained by photographing the object containing a material to be cooked can increase or decrease in proportion to the size of the mini-controller interface.

FIGS. 14 to 16 are views illustrating a human interface according to an embodiment of the present disclosure.

When the user presses a stop button in the pop-up interface (e.g., mini-controller interface) of FIG. 12, the cooking is canceled. Thus, the pop-up interface disappears as shown in FIG. 14. In addition, as shown in FIG. 14, a notification message “Cooking Stopped” or a toast message ToastMsg1 is displayed.

That is, when the cooking of the cooking appliance 1000 is finished or the cooking of the cooking appliance is paused or stopped in the mini-controller interface, the OS controller 200 (e.g., door controller) can display the temporary interface or notification (e.g., indicated by ToastMSG1) on a second area of the display on which the informational interface has been displayed.

The temporary interface can indicate one of the end of cooking, the pause of cooking, or the stop of cooking.

When the cooking has been completed in the pop-up of FIG. 12, the digital controller door displays a pop-up interface (e.g., mini-controller interface) and displays the cooking completion in the pop-up interface (e.g., mini-controller interface) as shown in FIG. 15. Since the cooking has been completed, the mini-controller interface of FIG. 15 does not have a separate operation button. The message “Cooking Finished” is displayed on the pop-up interface.

That is, as shown in FIG. 15, when a touch has been inputted to the stop button or the pause button of the mini-controller interface, or when the cooking process has been finished, the OS controller 200 (e.g., door controller) can display the occurrence of the touch input or the end of the cooking process in the display area (e.g., screen region iila of FIG. 13. of the mini-controller interface).

When, in the state of FIG. 14 or 15, the user opens the door, the screen is maintained as it is, and the mini-controller (e.g., pop-up interface) can disappear.

When, in the embodiment of FIG. 12 in which the cooking is in progress, the user opens the door, the cooking interface can be displayed instead of the informational interface as shown in FIG. 11.

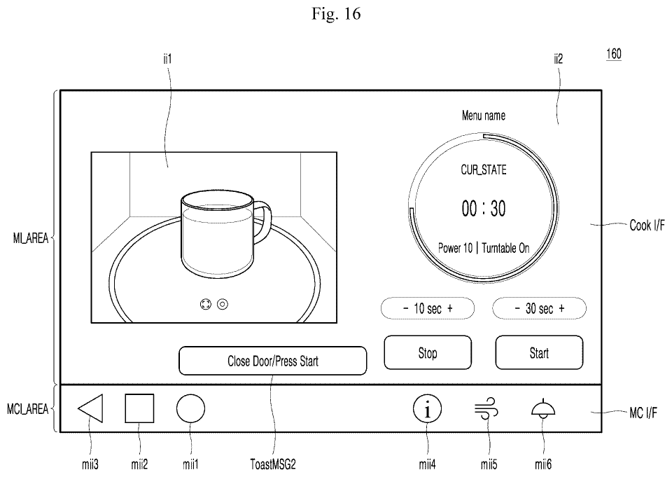

In addition to FIG. 11, since the door has been opened, a message (e.g., Close Door or/Press Start) for instructing the user to close the door or guiding the user to press the start button after closing the door can be provided as a toast message. In this regard, reference can be made to ToastMSG2 of FIG. 16.

FIG. 16 shows an interface displayed on the display 160 when a user opens the digital controller door during the cooking process. That is, FIG. 16 is a screen displayed by the digital controller door 100 when the door is opened during the cooking according to an embodiment of the present disclosure. If the door is opened during the cooking process and thus the cooking is paused, the remaining cooking time duration is displayed and the Stop/Start button is displayed. Also, if the door is opened during the cooking process while the screen in FIG. 15 is being displayed, the content or video can be paused, and the display can transition to displaying the screen in FIG. 16 while the door is open.

When the user selects the Start button without closing the door, a guide toast (such as “Close Door”) to guide the user to close the door and start the cooking can be displayed at a location of the ToastMSG2. In addition, when the user has closed the door, a toast message to guide the user to press the Start button to resume the cooking can be displayed at the position of ToastMSG2.

Screen region ii1 is an image captured by the second camera 110b inside the digital controller door 100. In one embodiment, screen area ii1 is an embodiment of an image obtained by photographing the inside of the cavity 1011 for a time duration immediately before the digital controller door 100 (e.g., display door) is opened. That is, the screen area ii1 can display an image or a video obtained by capturing the inside of the cavity 1011, and thus the user can identify the object (e.g., a cup) containing the material to be cooked which the user has put into the cavity, using the image or video.

Screen area ii2 is an interface for setting a cooking time duration of the cooking appliance 1000, and shows one embodiment of the cooking control input interface showing the cooking time duration for which the cooking has been performed just before the digital controller door 100 is opened or the remaining cooking time duration, and allowing the user to adjust the cooking time duration. The user can increase or decrease the cooking time duration on a 10 seconds or 30 seconds basis. + and − is one embodiment of an interface allowing the user to increase or decrease the cooking time duration.

Also, “Stop” and “Start” of screen region ii2 are buttons via which the cooking appliance receives an instruction on whether to end or resume the cooking from the user.

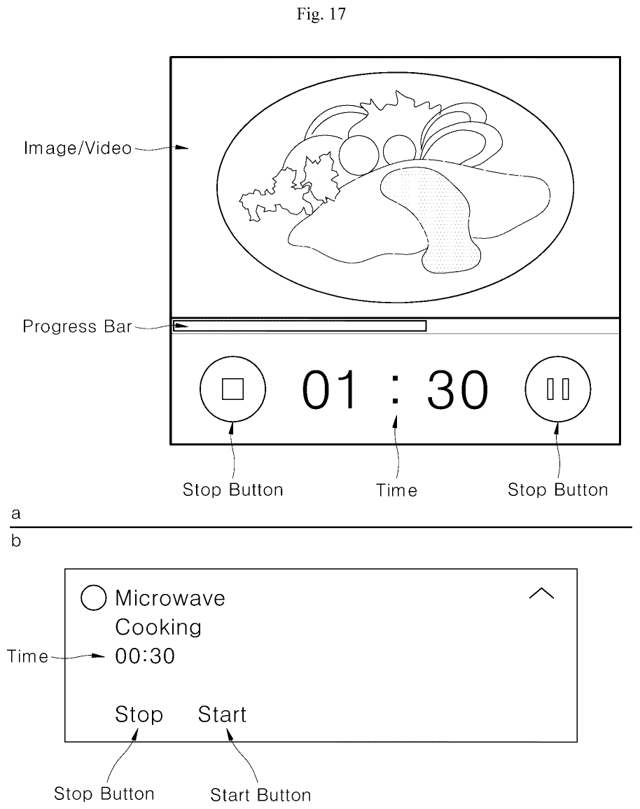

FIG. 17 is a diagram illustrating an implementation scheme of a pop-up interface, that is, a mini-controller interface, according to an embodiment of the present disclosure. The mini-controller can be configured in various ways, and more specifically, can include a configuration as shown in FIG. 17.

Also, part a of FIG. 17 shows an embodiment of the pop-up interface (mini-controller) of FIG. 12 described above.

Further, part b of FIG. 17 shows a pop-up interface (mini-controller) in a different manner as that in part a of FIG. 17.

An area indicated by Time displays the remaining time duration of cooking. Stop/Pause buttons in the area are interfaces on which the user can touch to instruct the end of cooking and the pause of cooking, respectively. The progress bar indicates the remaining time duration of a total cooking time duration.

The user continuously presses the pop-up interface of FIG. 17 and then, in this state, moves the pop-up interface to a specific position on an entirety of the screen (e.g., changing the mini-controller view to a maximized state). That is, the user can move the pop-up interface in the drag and drop manner. Alternatively, the user touches the image/video area and then touches a specific point on the screen, such that the pop-up interface can move to the specific point.

The image/video area can show a state of the inside of the cavity in which the cooking is being performed. Alternatively, an icon indicating a state in which the cooking is being performed can be displayed in the area. In addition, a message indicating whether the cooking is stopped or the cooking has been completed in relation to the current state can be displayed in the image/video area.

When the user selects the Stop button, the cooking can be finished and then the pop-up interface can be provided. When the Pause button is selected, the cooking is paused. Then, the pause button can be changed to a restart or resume button. When the user touches an area other than the pop-up interface, the screen returns to a full screen.

In one example, the pop-up interface can always be displayed during the cooking such that the cooking can be controlled and the cooking state can be checked. That is, the pop-up interface cannot be forcibly removed, but embodiments are not limited thereto.

When the user opens the door in the state as shown in FIG. 15 after the cooking has been completed, the pop-up interface (mini-controller) can disappear. After the cooking has been completed, and when the home button mii2 is selected in FIG. 12, the screen can be changed back to the screen shown in FIG. 11 such that the user can select additional cooking.

In one example, when the camera disposed inside the door takes an image of the inside of the cavity, the digital controller door (e.g., smart display door) can check whether a cooking target material (food) or an object (a bowl) containing the material has been input into the cavity. As a result, in response to that the cooking target material or the object containing the same is received/inputted into the cavity after the door is opened, a menu for allowing the user to select a cooking time duration or a cooking function can be displayed on the display 160. On the contrary, in response to that the cooking target material or the object containing the same is not received into the cavity after the door is opened, the digital controller door does not display a menu related to the cooking function on the screen.

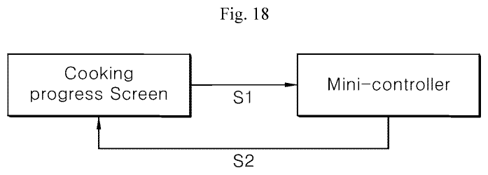

FIG. 18 is a diagram illustrating a process in which a mini-controller is displayed or disappears according to an embodiment of the present disclosure.

In the cooking process (e.g., including a pause situation and a stop situation), an input such as a user touching the display screen occurs or the digital controller door 100 (e.g., display door) is closed. Alternatively, the user touches a specific button (e.g., a back button) of the main control interface (MC I/F) area. In response thereto, the OS controller 200 (e.g., door controller) displays the mini-controller while removing the screen (e.g., screen as shown in FIG. 10 or 11) displayed on the digital controller door 100 in S1.

Even after the mini-controller has been displayed in the S1, the OS controller 200 (e.g., door controller) can display a cooking progress screen as shown in FIG. 10 or 11 via a process of touching a button displayed on the mini-controller or touching a notification message displayed as an alarm. In another example, even when the user touches an area (e.g., background screen) other than the mini-controller area in the state in which the mini-controller is displayed, the screen can be returned to the cooking progress screen in S2. According to the interface processing process of the OS controller 200 (e.g., door controller), when the user touches the main control interface (MC I/F) area, the operation S2 may not be performed.

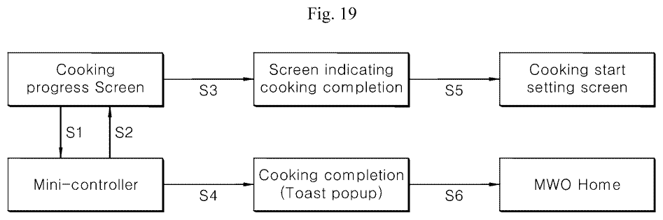

FIG. 19 is a diagram showing a flow of screen switching in a cooking completion process according to an embodiment of the present disclosure. S1 and S2 refer to the description of FIG. 18.

When cooking has been completed while the screen (e.g., FIG. 12, etc.) indicating the state in which the cooking is in progress is displayed in S3, the OS controller 200 (e.g., door controller) displays a screen (e.g., FIG. 15) indicating the cooking completion on the display 160. Thereafter, when a predetermined time duration has elapsed, a setting screen (a cooking start setting screen, for example, FIG. 10 or FIG. 11) on which the user can start further cooking is displayed on the display 160 in S5.

In addition, when cooking has been completed in a state in which the mini-controller is displayed, a toast message (e.g., MiniController of FIG. 15) can be displayed. Thereafter, the OS controller 200 can display a main screen (e.g., a main screen displayed when a home button is pressed) on the display 160 in S6.

In summary, the OS controller 200 (e.g., door controller) can display the cooking setting screen (e.g., a screen on which the start button has been pressed by the user before the cooking progress) before entering the cooking progress screen on the display 160 based on the cooking progress situation. Switching between the screens is performed in response to a predetermined area being selected or a function terminating or stopping.

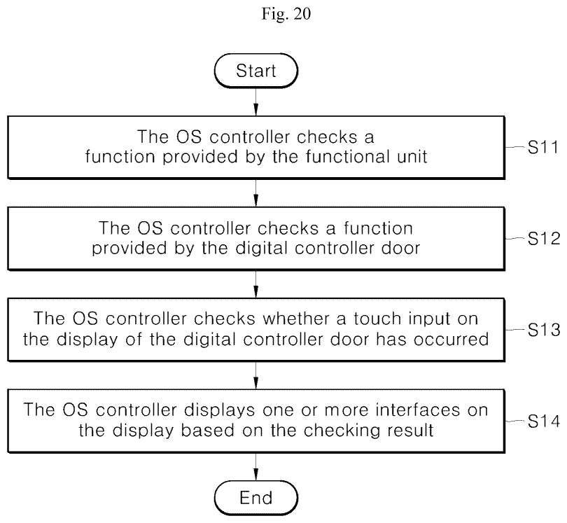

FIG. 20 is a diagram illustrating a process in which an OS controller (e.g., door controller) provides a human interface according to an embodiment of the present disclosure. The OS controller 200 (e.g., door controller) can check an operation state of each of the components of the cooking appliance and determine an interface to be output to the display 160 based on the checking result.

In an embodiment, the OS controller 200 (e.g., door controller) checks a function provided by the functional unit in S11 (e.g., is cooking food currently being performed?). The OS controller 200 can check a functional state such as whether the functional unit 500 currently performs cooking, operates the ventilation fan 590, or controls the outside lamp 580. To this end, the OS controller 200 (e.g., door controller) can receive information on the operation states of the components of the function unit 500 from the function controller 550 (e.g., main controller). This is performed in the function controller control and monitoring as one of the functions of the OS controller 200 (e.g., door controller).

In addition, the OS controller 200 (e.g., door controller) checks a function provided by the digital controller door 100 (e.g., display door) in S12 (e.g., is a movie being displayed? etc.). This is achieved in the O_element monitoring as one of the functions of the OS controller 200. It can be checked whether the speaker/microphone 130 is operating or whether the application unit 170 outputs specific information.

The OS controller 200 (e.g., door controller) checks whether a touch input on the display 160 of the digital controller door 100 has occurred in S13.

The OS controller 200 (e.g., door controller) displays one or more interfaces among the detailed interfaces of the human interface as described in FIG. 8 on the display 160 based on the checking results of S11, S12, and S13 in S14. In this process, in displaying the main control interface on the display 160, the OS controller 200 (e.g., door controller) can display an operation level of the ventilation fan 590 or whether to operate the outside lamp 580 as shown in mii5/mii6 of FIG. 9. For example, the display door can automatically and selectively transition between displaying different interface modes/views or screens based on what functions are currently being executing by the display door and the main oven portion when a user touches somewhere on the display. In this way, the cooking appliance can anticipate or guess the user's next move or intention, which can improve the user experience and better serve the user's needs.

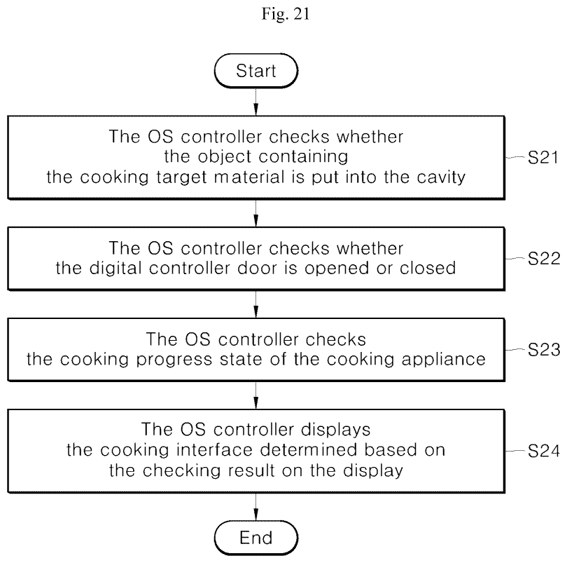

FIG. 21 is a diagram illustrating a process of displaying a cooking interface according to an embodiment of the present disclosure.

The OS controller 200 (e.g., door controller) checks whether the object (e.g., a bowl or a dish) containing the cooking target material is put into the cavity 1011 of the cooking appliance 1000 in S21. The OS controller 200 checks whether the digital controller door 100 is opened or closed in S22. The OS controller 200 checks the cooking progress state of the cooking appliance in S23. The cooking progress state refers to a state in which the cooking is paused during the cooking progress, or has been completed, or a state in which the cooking is in progress.

The OS controller 200 (e.g., door controller) displays the cooking interface determined based on the checking result on the display 160 in S24.

The cooking interface can include any one or more of the cooking control input interface, the cooking process display interface, and the mini-controller interface as described above.

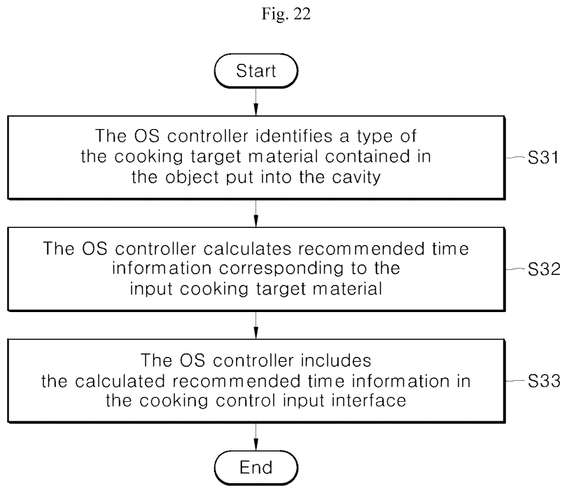

FIG. 22 is a diagram illustrating a process of presenting a cooking time duration suitable for a material to be cooked according to an embodiment of the present disclosure.

The OS controller 200 identifies a type of the cooking target material contained in the object (e.g., a cup, a mug, or a drink) put into the cavity 1011 in S31. The OS controller 200 (e.g., door controller) can perform image recognition and identification of the item and size or amount of material of the item to be cooked and calculates recommended time information corresponding to the input cooking target material in S32. For example, based on the type (e.g., liquid material) of the material contained in the cup received in the cavity or based on the size of the received object, the OS controller 200 (e.g., door controller) can automatically calculate recommended time information, which can improve user convivence and safety.

In addition, the OS controller 200 (e.g., door controller) can calculate recommended time information based on a past history of a cooking time duration set by the user after a similar material to the currently detected material was previously received into the cavity or a past record in which the user set a new cooking time duration again after a previous cooking has been terminated.

In addition, the OS controller 200 (e.g., door controller) can receive information related to the input material from the user through voice. For example, when the user speaks “meat thawing” by voice, the OS controller 200 can calculate recommended time information based on a cooking time duration required for the meat thawing.

Thereafter, the OS controller 200 (e.g., door controller) includes the calculated recommended time information in the cooking control input interface in S33. For example, when the user opens the digital controller door 100, puts the cup in the cavity 1011, and then closes the digital controller door 100, the OS controller 200 (e.g., door controller) can capture the inside of the cavity as shown in FIG. 11 and display a cooking time duration (e.g., 00:30 seconds) suitable for the capturing result in the cooking control input interface (e.g., screen area ii2) area. The cooking starts when the user directly presses the “Start” button.

When the user adjusts the cooking time duration (e.g., on a seconds or 30 seconds basis), the OS controller 200 (e.g., door controller) can store therein a mapping between the adjusted time information (e.g., a record of the user adding the 30 seconds after the time duration has been displayed as 30 seconds) and the input material type. The stored time information is applied to calculate a cooking time duration when the material of the same or similar type is put into the cavity later.

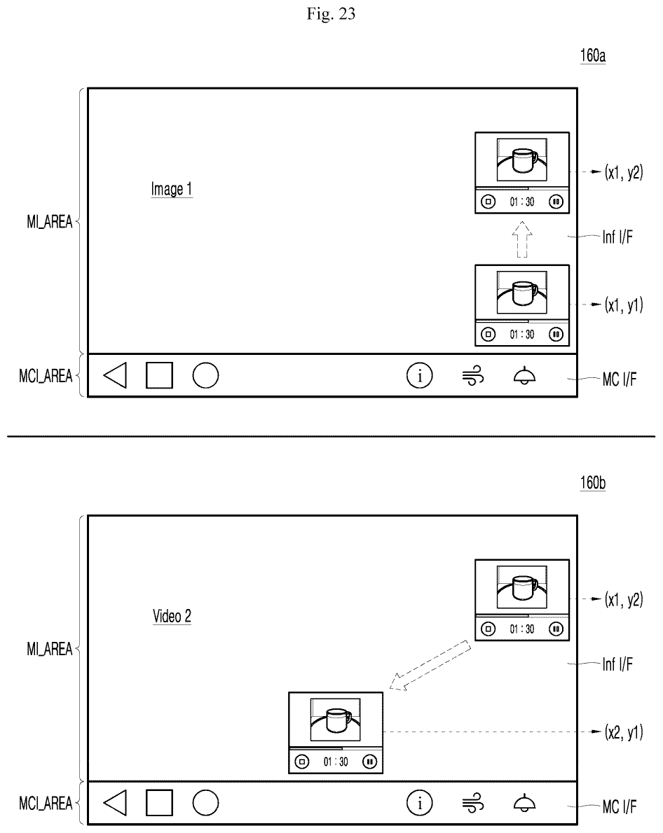

FIG. 23 is a diagram of storing and applying a location when a user moves the location of a mini-controller interface according to an embodiment of the present disclosure.

The informational interface can display various images or videos. For example, the OS controller 200 (e.g., door controller) can set the background screen to be displayed in each specific time zone or time of day or night according to the user's control or based on preset information. Alternatively, the OS controller 200 (e.g., door controller) can set an image or a video displayed on the informational interface according to a specific situation (e.g., season, anniversary, the type of cooking, morning routine, nighttime routine, etc.).

When the mini-controller interface is displayed on the informational interface on which the image or video is displayed, the mini-controller interface can be positioned to overlap with the image or video of the informational interface, so that the image or video may not be visible to the user.

Accordingly, in order to cope with this situation, the position of the mini-controller interface displayed on the informational interface is moved. In this situation, the OS controller 200 (e.g., door controller) can store therein a mapping between the position of the mini-controller interface and the image/video displayed on the informational interface.

For example, 160a shows a process in which the user moves the mini-controller interface to a position (x1, y2) in a state in which the mini-controller interface is displayed at a position (x1, y1) on the informational interface in which “Image1” is displayed.

In this regard, the OS controller 200 (e.g., door controller) stores therein a mapping (or correspondence) between the moved position information (x1, y2) of the mini-controller interface and the Image1.

Further, 160b shows a mini-controller interface at the position (x1, y2) on the informational interface “Video2” is displayed. In this regard, the positions (x1, y2) refers to the position to which the mini-controller interface had been previously moved in 160a.

In this regard, when the user has moved the mini-controller interface to the position (x2, y1), the OS controller 200 (e.g., door controller) stores therein a mapping (or correspondence) between the moved position information (x2, y1) of the mini-controller interface and the Video2.

Thereafter, the OS controller 200 (e.g., door controller) displays the mini-controller interface at the position (x1, y2) of the informational interface where the “Image1” is displayed. Similarly, the OS controller 200 displays the mini-controller interface at the position (x2, y1) of the informational interface where the “Video2” is displayed.

The position of the mini-controller interface can be updated according to the control of the user.

The above-described embodiment can also be applied to a situation in which the informational interface displays a specific web page or a specific application.

In summary, when the movement of the mini-controller interface occurs, the OS controller 200 (e.g., door controller) stores, in the internal memory, the mapping between the position of the mini-controller interface and identification information of an image, video, or application displayed on the informational interface. The OS controller 200 (e.g., door controller) displays, via the display of the display door, the mini-controller interface at the position stored in correspondence to (mapping with) the identification information on the informational interface in which the image, the video, or the application is displayed. As a result, when the user is viewing the contents displayed on the informational interface, the mini-controller interface may not interfere with the user viewing the contents.

When the above-described embodiment is implemented, various software or hardware of a door coupled to the cooking appliance can cooperate smoothly with a control component for controlling the cooking appliance, and a human interface for controlling the cooking appliance can be provided. In addition, the main control interface related to the interface-related control of the cooking appliance and the cooking interface for controlling the cooking state are provided, respectively or separately, so that the user can conveniently control the cooking appliance.

In particular, the OS controller (e.g., door controller) can store therein the stored information related to a previous control history or information on the material that has been previously cooked and then can control the interface based on the stored information in using the cooking appliance later. Thus, the human interface can be provided based on the use pattern of the cooking appliance.

An embodiment of the present disclosure can be applied to home appliances. A home appliance according to an embodiment of the present disclosure includes a display for providing a human interface and an OS controller (e.g., door controller) for controlling the same. In addition, the home appliance can include a functional unit. The function unit (e.g., main portion including components) can provide a unique function provided by the home appliance. For example, the home appliance can be a smart refrigerator, a smart steam closet for steaming clothes, a smart storage cabinet with one or more functions such a dehumidifier/humidifier/fan/lamp, a smart freezer, a smart storage safe, a smart oven or toaster, a smart dishwasher, a smart clothes washing machine, and a smart clothes dryer etc.

The display can display an image or video and receive a touch input, and the display can be divided into a first area and a second area.

The OS controller (e.g., door controller) can display at least one of an interface required to control the operation of the home appliance or an interface indicating the operation state of the home appliance on the first area of the display. In addition, the second area of the display can display an interface different from the interface output to the first area. A range or a position of each of the first and second areas can be changed.

The position of each of the first area and the second area can be changed in various ways, and the change of the position can be made via a user's touch or drag.

The interface displayed in the first area is displayed on the uppermost layer of the display and is in a state of being able to receive a touch input, and the OS controller (e.g., door controller) removes or displays the interface displayed in the first area according to the touch input made to the display or the operation state of the home appliance.

The first area of the display can output one of a temporal interface, a cooking interface, and an informational interface, and the second area can display the main control interface under the control of the OS controller (e.g., door controller).

The functional unit can provide a cooking function, and one embodiment of the home appliance includes a cooking appliance including a digital controller door providing a human interface.

The digital controller door can include a display for displaying an image or video and receiving a touch input, and an operating system (OS) controller configured to control the same.

The display can be divided into two or more areas. In this regard, the display can be controlled such that the interfaces respectively displayed in the different areas can be different from each other. Thus, the home appliance can display an interface suitable for the operation of the home appliance. As a result, the user can accurately control the operation of the home appliance or check the operation state of the home appliance. Also, different components and different embodiment can be combined with each other. For example, any of the operations discussed above as being performed by the door controller can be performed by the main controller. Also, according to another embodiment, the door controller and the main controller can be combined together in a same controller or their operation can be implemented by a single controller. For example, according to an embodiment, the door controller and the main oven controller can be parts of a same controller (e.g., different sections on a same chip or parts of a same printed circuit board, etc.). According to other embodiments, the appliance 1000 can be modified to be other types of home appliances other than a cooking appliance, such as a smart refrigerator, a smart steam closet for steaming clothes, a smart storage cabinet with one or more functions such a dehumidifier/humidifier/fan/lamp, a smart freezer, a smart storage safe, a smart oven or toaster, a smart dishwasher, a smart clothes washing machine, and a smart clothes dryer etc. For example, the appliance 1000 with a smart display door can be any type of home appliance that has a display door coupled to a main portion having a cavity, in which the main portion is configured to execute one or more functions unrelated to or independent from displaying (e.g., cooking, cooling/freezing, cleaning, washing, steaming, camera activation, etc.).

An embodiment of the present disclosure in which all the components are combined with each other or operate in combination with each other has been described. However, the present disclosure is not necessarily limited to this embodiment. Within the scope of the purpose of the present disclosure, at least two of all components can be selectively combined with other or can operate in the selectively combined manner with other. Furthermore, each of the components can be implemented as an independent hardware. However, some or all of the components can be selectively combined with each other and thus can be implemented using a computer program with a program module to perform some or all of the functions combined in one or more pieces of hardware. The codes and code segments that constitute the computer program can be easily deduced by a person skilled in the art from the present disclosure. The computer program can be stored in computer readable media and read and executed by a computer, thereby implementing the method of the present disclosure. The storage media for storing the computer program can include storage media including magnetic recording media, optical recording media, and semiconductor recording devices. Additionally, the computer program implementing an embodiment of the present disclosure includes a program module transmitted in real time duration through an external device.

Although the embodiments of the present disclosure have been described in more detail with reference to the accompanying drawings, the present disclosure is not necessarily limited to these embodiments, and can be modified in a various manner within the scope of the technical spirit of the present disclosure. Accordingly, the embodiments as disclosed in the present disclosure are intended to describe rather than limit the technical idea of the present disclosure, and the scope of the technical idea of the present disclosure is not limited by these embodiments. Therefore, it should be understood that the embodiments described above are not restrictive but illustrative in all respects. In addition, even though an effect of a configuration of the present disclosure is not explicitly described in describing the embodiment of the present disclosure above, it is obvious that the predictable effect from the configuration should be recognized.

What is claimed is:

1. A cooking appliance, comprising:
a main portion including a cavity for receiving food, and one or more functional components, the main portion being configured to provide a cooking function;
a display door coupled to the main portion, the display door including a display configured to display an image and receive a touch input; and
a controller configured to:
display a current screen in the display, the current screen including at least one of a cooking interface, an informational interface, a mini-controller interface and a temporal interface, and
in response to an occurrence of at least one of receiving the touch input on the display, a condition change of the main portion and a condition change of the display door, transition the current screen of the display to an updated screen that includes changing the at least one of cooking interface, an informational interface, a mini-controller interface and a temporal interface.

2. The cooking appliance of claim 1, wherein the controller is further configured to:
display a main control interface including a plurality of buttons or icons in a first area of the display, and display the current screen in a second area of the display.

3. The cooking appliance of claim 2, wherein the controller is further configured to:
always display the main control interface in the first area independent from or regardless of a type of screen displayed in the second area,
wherein the main control interface includes one or more of a home button, a back button, a stop button, a help button, a ventilation fan button and a lamp button.

4. The cooking appliance of claim 2, wherein the controller is further configured to:
in response to an occurrence of at least one of a cooking target being placed in the cavity, the display door being opened or closed, the cooking function being currently executing, the cooking function being paused or the cooking function reaching completion, display at least one of the cooking interface or the mini-controller interface in the second area of the display.

5. The cooking appliance of claim 2, wherein the controller is further configured to:
in response to the informational interface being displayed in the first area of the display while the cooking function is executing, display the mini-controller interface in the first area,
wherein the informational interface displays information unrelated to the cooking function.

6. The cooking appliance of claim 5, wherein the controller is further configured to:
in response to the mini-controller interface being moved from a first location within the first area to a second location within the first area while the informational interface is being displayed in the first area, store mapping information that maps the mini-controller interface to be displayed at the second location on the information interface.

7. The cooking appliance of claim 1, wherein the mini-controller interface includes a display area including an image or video of a cooking target in the cavity, a progress bar indicating a progress state of the cooking function, a stop button for stopping the cooking function, and a pause button for temporarily pausing the cooking function.

8. The cooking appliance of claim 7, wherein the controller is further configured to:
when the stop button is of the mini-controller interface is selected, terminate the cooking function being currently executing and provide the temporal interface for notifying that cooking has stopped.

9. The cooking appliance of claim 1, wherein the controller is further configured to:
in response to an occurrence of the touch input in an area other than the mini-controller, display full screen for cooking interface or informational interface.

10. The cooking appliance of claim 1, wherein the controller is further configured to:
in response to the door opening, terminate the cooking function being currently executing if cooking is in progress, remove the mini-controller and maintain other interfaces as same or change the information a interface to the cooking interface when the information interface is being displayed.

11. The cooking appliance of claim 2, wherein the controller is further configured to:
in response to the cooking function being temporarily paused, stopped or reaching cooking completion, display the temporary interface in the second area of the display,
wherein the temporary interface includes information about a cooking completion state of the cooking function, a paused state of the cooking function or a stopped state of the cooking function.

12. A method of controlling a cooking appliance, the method comprising:
displaying, by a controller, a current screen in the display, the current screen including at least one of a cooking interface, an informational interface, a mini-controller interface and a temporal interface; and
in response to an occurrence of at least one of receiving a touch input on the display, a condition change of the main portion and a condition change of a display door coupled to a main portion of the cooking appliance configured to provide a cooking function, transitioning, by the controller, the current screen of the display to an updated screen that includes changing the at least one of cooking interface, an informational interface, a mini-controller interface and a temporal interface.

13. The method of claim 12, the method comprising:
displaying a main control interface including a plurality of buttons or icons in a first area of the display; and
displaying the current screen in a second area of the display.

14. The method of claim 13, further comprising:
always displaying the main control interface in the first area independent from or regardless of a type of screen displayed in the second area,
wherein the main control interface includes one or more of a home button, a back button, a stop button, a help button, a ventilation fan button and a lamp button.

15. The method of claim 13, further comprising:
in response to an occurrence of at least one of a cooking target being placed in a cavity of the main portion, the display door being opened or closed, the cooking function being currently executing, the cooking function being paused or the cooking function reaching completion, displaying at least one of the cooking interface or the mini-controller interface in the second area of the display.

16. The method of claim 13, further comprising:
in response to the informational interface being displayed in the first area of the display while the cooking function is executing, displaying the mini-controller interface in the first area,
wherein the informational interface displays information unrelated to the cooking function.

17. The method of claim 16, further comprising:
in response to the mini-controller interface being moved from a first location within the first area to a second location within the first area while the informational interface is being displayed in the first area, storing mapping information that maps the mini-controller interface to be displayed at the second location on the information interface.

18. The method of claim 12, wherein the mini-controller interface includes a display area including an image or video of a cooking target in the cavity, a progress bar indicating a progress state of the cooking function, a stop button for stopping the cooking function, and a pause button for temporarily pausing the cooking function.

19. The cooking appliance of claim 18, further comprising:
when the stop button is of the mini-controller interface is selected, terminating the cooking function being currently executing; and
providing the temporal interface for notifying that cooking has stopped.

20. The method of claim 13, further comprising:
in response to the cooking function being temporarily paused, stopped or reaching cooking completion, displaying the temporary interface in the second area of the display,
wherein the temporary interface includes information about a cooking completion state of the cooking function, a paused state of the cooking function or a stopped state of the cooking function.
